(19) United States
(12) Patent Application Publication
(10) Pub. No.: US 2014/0330469 A1
(43) Pub. Date: Nov. 6, 2014

(54) CONTROL DEVICE

(71) Applicant: AISIN AW CO., LTD., Anjo-shi, Aichi-ken (JP)

(72) Inventors: Takashi Yoshida, Nishio (JP); Yomei Hakumura, Susono (JP); Yoichi Tajima, Anjo (JP); Jin Izawa, Obu (JP)

(21) Appl. No.: 14/346,633

(22) PCT Filed: Nov. 28, 2012
(86) PCT No.: PCT/JP2012/080755

§ 371 Date: Mar. 21, 2014

(30) Foreign Application Priority Data
Nov. 29, 2011 (JP) 2011-260691

(51) Int. Cl. B60W 20/00; B60W 10/06; B60W 10/08; B60W 10/02

(52) U.S. Cl. CPC B60W 20/40; B60W 10/02; B60W 10/06; B60W 10/08; Y10S 903/93
USPC 701/22; 180/65.265; 903/930

(57) ABSTRACT

A control device for a hybrid vehicle performs start control for an internal combustion engine. The start control includes (i) transition control that controls the transition of first and second engagement devices between a direct engagement state, a slip engagement state and a disengaged state, and (ii) rotational speed control that controls rotational speed of a rotary electric machine. The timing of the transition control and rotational speed control reduces the starting time of the internal combustion engine, and/or suppresses transmission of torque shock to wheels when the first engagement device transitions from the slip engagement state to the direct engagement state.

### BACKGROUND

The present invention relates to a control device that controls a vehicle drive device in which a rotary electric machine is arranged on a power transmission path that connects an internal combustion engine to wheels, a first engagement device is arranged between the internal combustion engine and the rotary electric machine, and a second engagement device is arranged between the rotary electric machine and the wheels.

Technologies described in Patent Document 1 and Patent Document 2 are already known as examples of the control device described above. In the technologies described in Patent Document 1 and Patent Document 2, the control devices are configured to, in a case in which a request to start an internal combustion engine is provided while a first engagement device is in a disengaged state and a second engagement device is in a direct engagement state, cause the first engagement device to transition to a slip engagement state and execute start control for the internal combustion engine that increases a rotational speed of the internal combustion engine using a rotational driving force of a rotary electric machine.

In the technology of the Patent Document 1, in order to shorten a starting time of the internal combustion engine, the control device is configured to start transition of the first engagement device from the disengaged state to the slip engagement state before transition of the second engagement device from the direct engagement state to the slip engagement state.

In the technology of Patent Document 1, the control device is configured to, at the time of causing the first engagement device to transition to the slip engagement state, even if slip torque of a magnitude of a transmission torque capacity of the first engagement device is transmitted from the rotary electric machine to the internal combustion engine, compensate an amount of torque decreased due to the slip torque in a feedforward manner by adding a target transmission torque capacity of the first engagement device to a target torque of the rotary electric machine such that the torque that is transmitted from the rotary electric machine to the wheels does not decrease.

However, in the technology of Patent Document 1, in a case in which there is a compensation error in the slip torque of the first engagement device, there has been a risk that torque shock due to the compensation error is transmitted to the wheels through the second engagement device, which is in the direct engagement state, and gives a driver an uncomfortable feeling.

In addition, in the technology of Patent Document 2, the control device is configured to, in a case in which a start method of the internal combustion engine in which the second engagement device is not controlled to be brought into the slip engagement state is selected, perform rotational speed control for the rotary electric machine by setting a target rotational speed. Although the technology of Patent Document 2 does not disclose the configuration of setting the target rotational speed in detail, it is supposed that the rotational speed control acts to reduce the torque shock when the first engagement device transitions to the slip engagement state. However, in Patent Document 2, the first engagement device transitions from the slip engagement state to the direct engagement state while the second engagement device is in the direct engagement state; therefore, there is a limit to how much the transmission of the torque shock to the wheels can be suppressed when the first engagement device transitions from the slip engagement state to the direct engagement state.

### RELATED-ART DOCUMENTS

### Patent Documents

Patent Document 1: Japanese Patent Application Publication No. 2007-99141 (JP 2007-99141 A)

Patent Document 2: Japanese Patent Application Publication No. 2011-20543 (JP 2011-20543 A)

### SUMMARY

It is therefore desired to implement a control device that, in a case in which, to shorten a starting time of the internal combustion engine, the transition of the first engagement device from the disengaged state to the slip engagement state starts before the second engagement device transitions from the direct engagement state to the slip engagement state, is capable of suppressing the transmission of the torque shock to the wheels due to a fluctuation in the transmission torque capacity of the first engagement device as well as suppressing the transmission of the torque shock to the wheels when the first engagement device transitions from the slip engagement state to the direct engagement state.

According to an aspect of the present invention, there is provided a control device that controls a vehicle drive device in which a rotary electric machine is arranged on a power transmission path that connects an internal combustion engine to wheels, a first engagement device is arranged between the internal combustion engine and the rotary electric machine, and a second engagement device is arranged between the rotary electric machine and the wheels. In response to a request to start the internal combustion engine that is received while the first engagement device is in a disengaged state and the second engagement device is in a direct engagement state, the control device performs start control for the internal combustion engine that increases a rotational speed of the internal combustion engine using a rotational driving force of the rotary electric machine. The start control comprises:

after the request to start the internal combustion engine is received, starting first transition control that causes the first engagement device to transition from the disengaged state to a slip engagement state and second transition control that causes the second engagement device to transition from the direct engagement state to the slip engagement state;

before the first engagement device transitions from the disengaged state to the slip engagement state, starting rotational speed control that controls the rotary electric machine such that a rotational speed of the rotary electric machine achieves a target rotational speed;

in a state in which the second engagement device is brought into a predetermined slip engagement state, or in which an amount of change, in a decreasing direction, of output torque caused by the rotational speed control becomes equal to or greater than a predetermined value, determining that the second engagement device has transitioned from the direct engagement state to the slip engagement state; and

after it is determined that the second engagement device has transitioned from the direct engagement state to the slip engagement state, causing the first engagement device to transition from the slip engagement state to the direct engagement state.

The term “rotary electric machine” in the present application refers to any of a motor (electric motor), a generator (electric generator), and a motor generator that functions both as a motor and as a generator as necessary.

In the present application, the expression “drivingly coupled” refers to a state in which two rotating elements are coupled together such that a driving force can be transmitted between the two rotating elements, and is used as a concept including a state in which the two rotating elements are coupled together so as to rotate together, or a state in which the two rotating elements are coupled together such that the driving force can be transmitted between the two rotating elements via one or more transmission members. Such transmission members include various kind of members that transmit rotation at the same speed or at a shifted speed, and include, e.g., a shaft, a gear mechanism, a belt, a chain, etc. In addition, such transmission members may include an engagement device that selectively transmits rotation and a driving force, such as, e.g., a friction engagement device, a meshing engagement device, etc.

According to such a characteristic configuration, after a request to start the internal combustion engine is provided, the control device starts the first transition control that causes the first engagement device to transition from the disengaged state to the slip engagement state and also starts the second transition control that causes the second engagement device to transition from the direct engagement state to the slip engagement state. Thereby, it is possible to shorten the time required to start the internal combustion engine.

In addition, at the time of causing the first engagement device to transition from the disengaged state to the slip engagement state, even if the torque shock is transmitted from the first engagement device to the rotary electric machine due to the change in the transmission torque capacity of the first engagement device; because the rotational speed control is being executed, output torque of the rotary electric machine is corrected so as to decrease the change in the rotational speed of the rotary electric machine that is caused by the torque shock. Thereby, the output torque of the rotary electric machine is corrected so as to cancel the torque shock and it is possible to suppress the transmission of the torque shock from the rotary electric machine to the wheels through the second engagement device in the direct engagement state.

In addition, according to the characteristic configuration described above, after it is determined that the second engagement device has transitioned to the slip engagement state, the control device causes the first engagement device to transition from the slip engagement state to the direct engagement state. Thereby, even if the torque shock is transmitted from the first engagement device to the second engagement device when the first engagement device transitions from the slip engagement state to the direct engagement state, it is possible to reliably prevent the torque shock from being transmitted from the second engagement device to the wheels.

In addition, even during execution of the rotational speed control, it is possible to decrease a rate of change of the rotational speed of the wheels. Thereby, it is possible to cause the second engagement device to transition to the slip engagement state by increasing a rotational speed difference between the engagement members of the second engagement device. Therefore, it is possible to determine that the second engagement device has transitioned to the slip engagement state when the second engagement device is brought into a predetermined slip engagement state, as the aforementioned configuration.

Alternatively, when the second engagement device is brought into the slip engagement state, the rate of change of the rotational speed of the rotary electric machine tries to increase. However, the increase in the rate of change of the rotational speed of the rotary electric machine is suppressed through the rotational speed control. At this time, the output torque changes in the decrease direction through the rotational speed control. Therefore, as the aforementioned configuration, when the change amount in the decrease direction of the output torque through the rotational speed control becomes equal to or greater than a predetermined value, it is possible to determine that the second engagement device has been brought into the slip engagement state.

In the rotational speed control, it is preferable that the control device: before it is determined that the second engagement device has transitioned from the direct engagement state to the slip engagement state, estimates, based on a change in the rotational speed of the rotary electric machine, transmission path input torque that is torque inputted to the power transmission path; estimates external input torque that is torque inputted from the wheels to the power transmission path, by subtracting at least output torque of the rotary electric machine from the transmission path input torque; sets, as the target rotational speed, a rotational speed that is calculated based on the external input torque and vehicle required torque that is torque required to drive the wheels; and after it is determined that the second engagement device has transitioned from the direct engagement state to the slip engagement state, sets, as the target rotational speed, a rotational speed that is by a predetermined value higher than the rotational speed of the rotary electric machine in a case in which the second engagement device is in the direct engagement state.

According to such a configuration, before it is determined that the second engagement device has transitioned from the direct engagement state to the slip engagement state, the target rotational speed is calculated based on the estimated value of the external input torque and the vehicle required torque. Therefore, it is possible to perform the rotational speed control using the fluctuation in the rotational speed due to the torque shock that is a disturbance element toward the external input torque and the vehicle required torque as a deviation from the target rotational speed. Thereby, through the rotational speed control, the output torque of the rotary electric machine can be controlled so as to cancel the torque shock caused when the first engagement device transitions from the disengaged state to the slip engagement state. The target rotational speed of the rotary electric machine is calculated based on the estimated external input torque in addition to the vehicle required torque. Therefore, it is possible to calculate the target rotational speed that does not cancel the external input torque by reflecting travel resistance torque, braking torque, etc. into the vehicle required torque. Thus, it is possible to reduce the fluctuation component of the rotational speed of the rotary electric machine due to the torque shock while maintaining acceleration and deceleration of the vehicle due to a travel state, a braking operation, etc. In addition, according to the aforementioned configuration, the transmission path input torque inputted to the power transmission path can be estimated based on the change in the rotational speed of the rotary electric machine. The estimated value of the external input torque is computed by subtracting the output torque of the rotary electric machine from the estimated transmission path input torque. Therefore, in addition to the output torque of the rotary electric machine, the torque inputted to the power transmission path can be accurately estimated. Thus, it is possible to improve the estimation accuracy of the external input torque inputted from the wheels to the power transmission path.

On the other hand, after it is determined that the second engagement device has transitioned from the direct engagement state to the slip engagement state, the target rotational speed is set to a rotational speed that is by a predetermined value higher than the rotational speed of the rotary electric machine in a case in which the second engagement device is in the direct engagement state. Therefore, when the first engagement device transitions from the slip engagement state to the direct engagement state, even if the torque shock is transmitted from the first engagement device to the rotary electric machine, it is possible to maintain the rotational speed of the rotary electric machine at around the target rotational speed that is by the predetermined value higher than the rotational speed of the rotary electric machine in a case in which the second engagement device is in the direct engagement state and maintain the second engagement device in the slip engagement state. Thus, it is possible to reliably prevent the torque shock from being transmitted to the wheels.

It is preferable that the disengaged state of the first engagement device is a state in which no transmission torque capacity is generated in the first engagement device, the slip engagement state of the first engagement device is a state in which transmission torque capacity is generated in the first engagement device and there is a difference between the rotational speed of the internal combustion engine and the rotational speed of the rotary electric machine, the direct engagement state of the first engagement device is a state in which transmission torque capacity is generated in the first engagement device and there is no difference between the rotational speed of the internal combustion engine and the rotational speed of the rotary electric machine, the slip engagement state of the second engagement device is a state in which transmission torque capacity is generated in the second engagement device and there is a difference between rotational speeds of two engagement members of the second engagement device, and the direct engagement state of the second engagement device is a state in which transmission torque capacity is generated in the second engagement device and there is no difference between the rotational speeds of the two engagement members of the second engagement device.

According to such a configuration, the engagement states of the first engagement device and the second engagement device are appropriately controlled.

It is preferable that starting the first transition control means providing a request to cause the first engagement device to generate transmission torque capacity, and starting the second transition control means providing a request to gradually decrease the transmission torque capacity generated in the second engagement device until the difference between the rotational speeds of the two engagement members of the second engagement device is generated.

According to such a configuration, after the first transition control starts, it is possible to generate transmission torque capacity in the first engagement device, and after the second transition control starts, it is possible to decrease the transmission torque capacity in the second engagement device until the rotational speed difference is generated between the engagement members of the second engagement device.

It is preferable that, during execution of the rotational speed control, the control device causes the first engagement device to transition from the disengaged state to the slip engagement state, and thereafter, causes the second engagement device to transition from the direct engagement device to the slip engagement device.

According to such a configuration, it is possible to cause the first engagement device to transition to the slip engagement state before the second engagement device transitions to the slip engagement state. Therefore, the time required to start the internal combustion engine can be shortened. At this moment, the rotational speed control is being executed. Therefore, even in a case in which the transition of the first engagement device to the slip engagement state is performed before the second engagement device transitions to the slip engagement state, it is possible, through the rotational speed control, to suppress that the torque shock caused by the transition of the first engagement device to the slip engagement state is transmitted from the rotary electric machine to the wheels through the second engagement device.

It is preferable that, when the second engagement device is brought into the predetermined slip engagement state means when a rotational speed difference that corresponds to a rotational speed difference between the engagement members of the second engagement device that is calculated based on the rotational speed of the rotary electric machine and the rotational speed of the wheels becomes equal to or greater than a predetermined value, and the rotational speed difference that corresponds to the rotational speed difference between the engagement members of the second engagement device is generated by the rotational speed of the wheels falling below the rotational speed of the wheels in a case in which the second engagement device is in the direct engagement device when the rotational speed of the rotary electric machine is controlled so as to achieve the target rotational speed.

As mentioned above, when the second engagement device is brought into the slip engagement state, the rate of change of the rotational speed of the rotary electric machine tries to increase. However, through the rotational speed control, the increase in the rate of change of the rotational speed of the rotary electric machine is suppressed. However, even during the execution of the rotational speed control, when the second engagement device is brought into the slip engagement state, the rate of change of the rotational speed of the wheels is decreased. Therefore, the rotational speed difference between the engagement members of the second engagement device increases. That is, the rotational speed difference between the engagement members of the second engagement device is generated by the rotational speed of the wheels falling below the rotational speed of the wheels in a case in which the second engagement device is in the direct engagement state when the rotational speed of the rotary electric machine is controlled so as to achieve the target rotational speed. According to such a configuration, the rotational speed difference that corresponds to the rotational difference between the engagement members of the second engagement device is calculated based on the rotational speed of the rotary electric machine and the rotational speed of the wheels. Therefore, when the calculated rotational speed difference becomes equal to or greater than a predetermined value, it is possible to determine that the second engagement device has transitioned from the direct engagement state to the slip engagement state.

### BRIEF DESCRIPTION OF THE DRAWINGS

FIG. 1 is a schematic diagram showing a schematic configuration of a vehicle drive device and a control device according to an embodiment of the present invention;

FIG. 2 is a block diagram showing a schematic configuration of the control device according to the embodiment of the present invention;

FIG. 3 is a timing chart showing processing of start control according to the embodiment of the present invention;

FIG. 4 is a timing chart showing conventional processing of start control;

FIG. 5 is a timing chart illustrating a control behavior when a first engagement device is in a slip engagement state according to the embodiment of the present invention;

FIG. 6 is a flow chart showing processing of the control device according to the embodiment of the present invention;

FIG. 7 is a block diagram showing a configuration of a direct rotational speed control section according to the embodiment of the present invention.

FIG. 8 shows a model as an elastic system of a power transmission path according to the embodiment of the present invention;

FIG. 9 shows a model as a two-inertia system of a power transmission path according to the embodiment of the present invention;

FIG. 10 is a Bode plot illustrating processing of the direct rotational speed control according to the embodiment of the present invention;

FIG. 11 is a timing chart illustrating the processing of the direct rotational speed control according to a comparison example of the present invention;

FIG. 12 is a timing chart illustrating the processing of the direct rotational speed control according to the embodiment of the present invention;

FIG. 13 is a schematic diagram showing a schematic configuration of a vehicle drive device and a control device according to another embodiment of the present invention; and

FIG. 14 is a schematic diagram showing a schematic configuration of a vehicle drive device and a control device according to a further embodiment of the present invention.

### DETAILED DESCRIPTION OF EMBODIMENTS

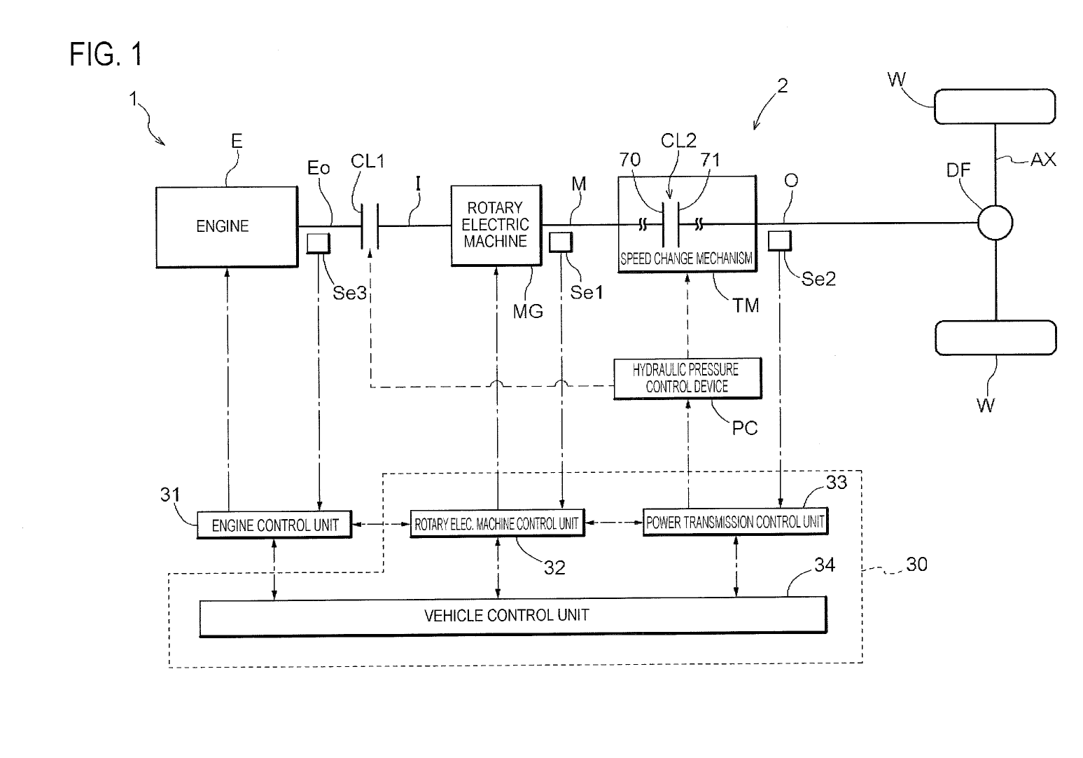

A control device 30 according to an embodiment of the present invention will be described with reference to the drawings. FIG. 1 is a schematic diagram showing a schematic configuration of a vehicle drive device 1 and a control device 30 according to the present embodiment. In this figure, a solid line indicates a transmission path of a driving force, a dashed line indicates a supply path of hydraulic oil, and a dashed dotted line indicates a transmission path of signals. As shown in this figure, the vehicle drive device 1 according to the present embodiment schematically includes an engine E and a rotary electric machine MG as driving force sources and is configured to transmit a driving force from these driving force sources to wheels W through a power transmission mechanism. The vehicle drive device 1 includes the rotary electric machine MG provided on a power transmission path 2 that connects the engine E to the wheels W, a first engagement device CL1 provided between the engine E and the rotary electric machine MG, and a second engagement device CL2 provided between the rotary electric machine MG and the wheels W. The first engagement device CL1 is selectively brought into a coupled state or a released state between the engine E and the rotary electric machine MG in accordance with the engagement state. The second engagement device CL2 is selectively brought into a coupled state or a released state between the rotary electric machine MG and the wheels W in accordance with the engagement state. The vehicle drive device 1 according to the present embodiment includes a speed change mechanism TM provided on the power transmission path 2 between the rotary electric machine MG and the wheels W. The second engagement device CL2 is one of a plurality of engagement devices provided in the speed change mechanism TM.

A hybrid vehicle includes the control device 30 that controls the vehicle drive device 1. The control device 30 according to the present embodiment includes: a rotary electric machine control unit 32 that performs control for the rotary electric machine MG; a power transmission control unit 33 that performs control for the speed change mechanism TM, the first engagement device CL1, and the second engagement device CL2; and a vehicle control unit 34 that integrates these control devices and performs control for the vehicle drive device 1. In addition, the hybrid vehicle includes an engine control device 31 that performs control for the engine E.

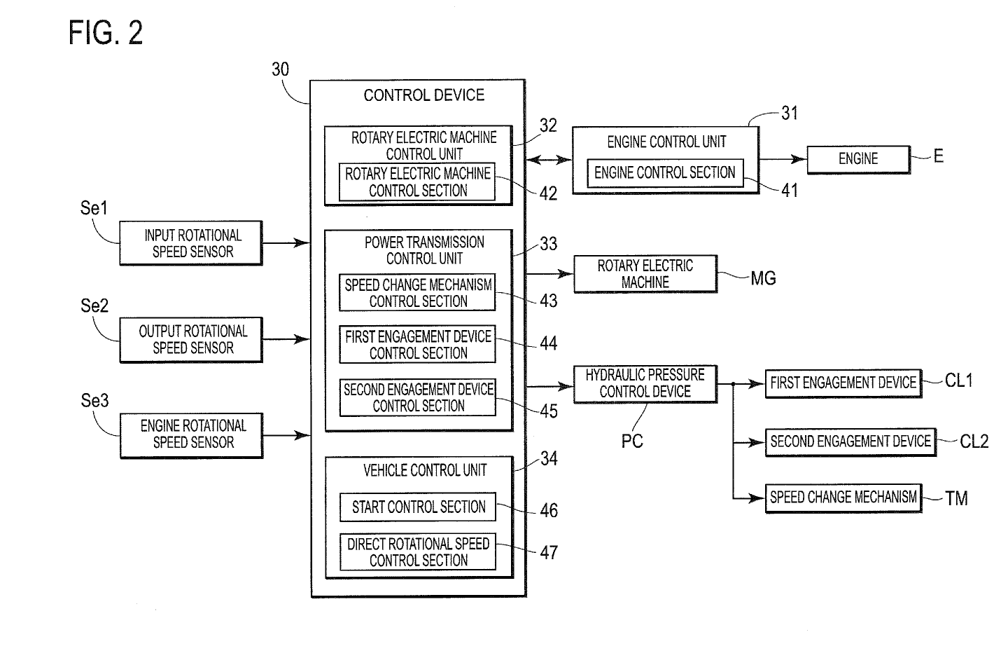

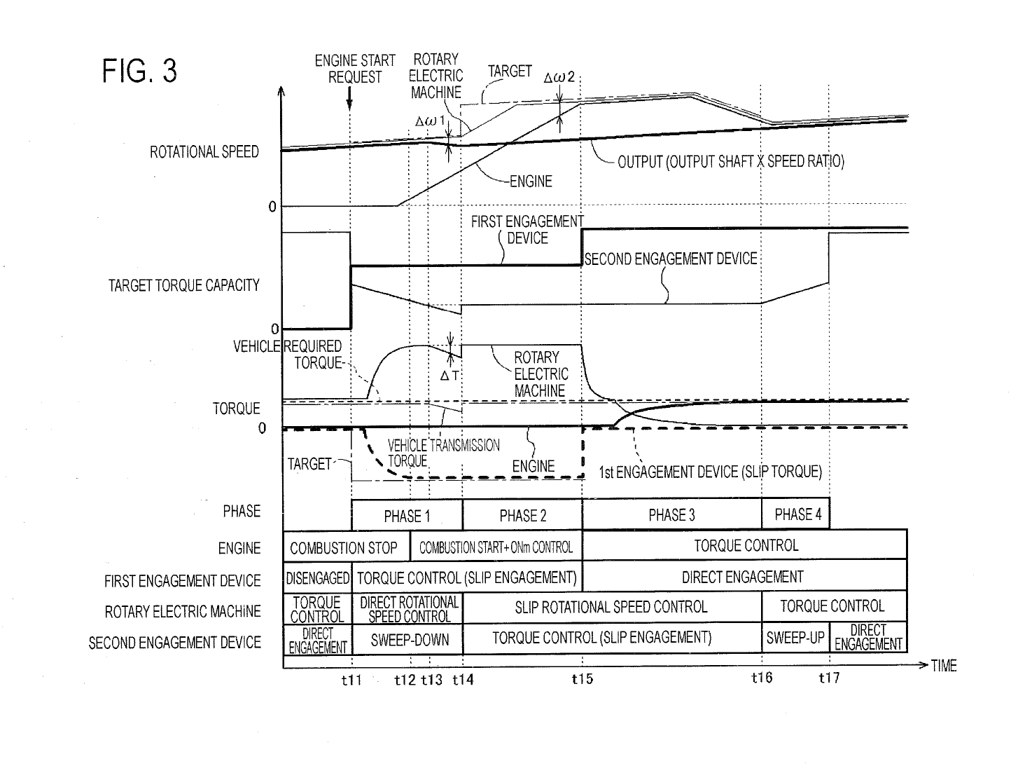

As shown in FIGS. 2 and 3, the control device 30 includes a start control section 46 that performs start control for the engine E that increases a rotational speed of the engine E using a rotational driving force of the rotary electric machine MG in a case in which a request to start the engine E is provided while the first engagement device CL1 is in a disengaged engagement state and the second engagement device CL2 is in the direct engagement state.

After a request to start the engine E is provided, the start control section 46 starts first transition control that causes the first engagement device CL1 to transition from the disengaged engagement state to the slip engagement state and second transition control that causes the second engagement device CL2 to transition from the direct engagement state to the slip engagement state. Before the first engagement device CL1 transitions from the disengaged state to the slip engagement state, the start control section 46 starts rotational speed control that controls the rotary electric machine MG such that a rotational speed of the rotary electric machine MG achieves a target rotational speed. Thereafter, when the second engagement device CL2 is brought into a predetermined slip engagement state, or when a change amount ΔT in a decrease direction of output torque caused by the rotational speed control becomes equal to or greater than a predetermined value, the start control section 46 determines that the second engagement device CL2 has transitioned from the direct engagement state to the slip engagement state. After such a determination, the start control section 46 causes the first engagement device CL1 to transition from the slip engagement state to the direct engagement state.

Hereinafter, the vehicle drive device 1 and the control device 30 according to the present embodiment are explained in detail.

1. Configuration of Vehicle Drive Device 1

Initially, the configuration of the vehicle drive device 1 of a hybrid vehicle according to the present embodiment is explained. As shown in FIG. 1, the hybrid vehicle includes the engine E and the rotary electric machine MG as the driving force sources of the vehicle and is a parallel type hybrid vehicle in which the engine E and the rotary electric machine MG are drivingly coupled in series. The hybrid vehicle includes the speed change mechanism TM, and using the speed change mechanism TM, shifts the rotational speed ωm of the engine E and the rotary electric machine MG transmitted to an intermediate shaft M, converts the torque, and transmits the resultant rotational speed and torque to an output shaft O.

The engine E is an internal combustion engine driven by combusting fuel. Various kinds of known engines, for example, a gasoline engine, a diesel engine, etc. are used as the engine E. In the present example, an engine output shaft Eo, such as a crankshaft, of the engine E is selectively drivingly coupled to the input shaft I via the first engagement device CL1. The input shaft I is drivingly coupled to the rotary electric machine MG. That is, the engine E is selectively drivingly coupled to the rotary electric machine MG via the first engagement device CL1 serving as a friction engagement element. In addition, the engine output shaft Eo is provided with a damper and is configured to be capable of damping fluctuations in output torque and the rotational speed due to intermittent combustion of the engine E and transmitting the torque and rotational speed to the wheels W.

The rotary electric machine MG includes a stator fixed to a non-rotatable member and a rotor that is rotatably supported in an inward radial direction at a position facing the stator. The rotor of the rotary electric machine MG is drivingly coupled to the input shaft I and the intermediate shaft M so as to rotate together. That is, in the present embodiment, both engine E and the rotary electric machine MG are configured to be drivingly coupled to the input shaft I and the intermediate shaft M. The rotary electric machine MG is electrically connected to a battery serving as an electricity storage device via an inverter device that performs conversion between direct current and alternating current. The rotary electric machine MG is capable of performing a function as a motor (an electric motor) that generates motive power when receiving electric power supply and a function as a generator (an electric generator) that generates electric power when receiving motive power supply. That is, the rotary electric machine MG is supplied with electric power from the battery to perform power running, or generates electric power using a rotational driving force transmitted from the engine E or the wheels W to store the generated electric power in the battery via the inverter.

The intermediate shaft M that is drivingly coupled to the driving force sources is drivingly coupled to the speed change mechanism TM. In the present embodiment, the speed change mechanism TM is an automatic speed change mechanism that includes a plurality of shift speeds with different speed ratios. In order to establish the plurality of shift speeds, the speed change mechanism TM includes a gear mechanism such as a planetary gear mechanism, and a plurality of engagement devices. In the present embodiment, one of the plurality of engagement devices is the second engagement device CL2. The speed change mechanism TM shifts the rotational speed of the intermediate shaft M at a speed ratio set for each shift speed and converts the torque thereof, and transmits the resultant rotational speed and torque to the output shaft O. The torque transmitted from the speed change mechanism TM to the output shaft O is distributed and transmitted to axle shafts AX on the right and left sides through an output differential gear device DF, and thereafter transmitted to the wheels W that are coupled to the respective axle shafts AX. The speed ratio here is a ratio of the rotational speed of the intermediate shaft M to the rotational speed of the output shaft O when each shift speed is established in the speed change mechanism TM. In the present application, the speed ratio is a value acquired by dividing the rotational speed of the intermediate shaft M by the rotational speed of the output shaft O. That is, the rotational speed acquired by dividing the rotational speed of the intermediate M by the speed ratio is the rotational speed of the output shaft O. In addition, the torque acquired by multiplying the torque transmitted from the intermediate shaft M to the speed change mechanism TM by the speed ratio is the torque transmitted from the speed change mechanism TM to the output shaft O.

In the present example, a plurality of engagement devices (including the second engagement device CL2) in the speed change mechanism TM and the first engagement device CL1 are friction engagement elements such as clutches, brakes, etc., each including friction members. These friction engagement elements are capable of continuously controlling an increase and a decrease in the transmission torque capacity by controlling the hydraulic pressure that is supplied to control the engagement pressure. It is preferable to utilize, for example, a wet multi-plate clutch, a wet multi-plate brake, etc. as such friction engagement elements.

The friction engagement element transmits torque between engagement members with friction between the engagement members. In a case in which there is a rotational difference (slip) between the engagement members of the friction engagement element, the torque (slip torque) of the magnitude of the transmission torque capacity is transmitted from the member with a higher rotational speed to the member with a lower rotational speed with dynamic friction. In a case in which there is no rotational difference (slip) between the engagement members of the friction engagement element, the friction engagement element transmits the torque acting between the engagement members of the friction engagement element with static friction up to the magnitude of the transmission torque capacity. The transmission torque capacity here is the maximum magnitude of torque that can be transmitted with friction by the friction engagement element. The magnitude of the transmission torque capacity changes in proportion to the engagement pressure of the friction engagement element. The engagement pressure is a pressure at which an input-side engagement member (a friction plate) and an output-side engagement member (a friction plate) press each other. In the present embodiment, the engagement pressure changes in proportion to the magnitude of the hydraulic pressure that is supplied. That is, in the present embodiment, the magnitude of the transmission torque capacity changes in proportion to the magnitude of the hydraulic pressure that is supplied to the friction engagement element.

Each friction engagement element includes a return spring and is urged toward a disengagement side by a reaction force of the spring. When the force generated by the hydraulic pressure that is supplied to a hydraulic cylinder of each friction engagement element exceeds the reaction force of the spring, the transmission torque capacity starts to be generated in the friction engagement element and the friction engagement element changes from the disengaged state to the engagement state. The hydraulic pressure at the time when the transmission torque capacity starts to be generated is referred to as “stroke end pressure.” Each friction engagement element is configured such that the transmission torque capacity increases in proportion to the increase in the hydraulic pressure after the hydraulic pressure that is supplied exceeds the stroke end pressure. In addition, the friction engagement element may be configured not to include a return spring and to control the transmission torque capacity with differential pressure generated on both sides of a piston of the hydraulic cylinder.

In the present embodiment, the engagement state means a state in which transmission torque capacity is generated in the friction engagement element and includes the slip engagement state and the direct engagement state. The disengaged state means a state in which no transmission torque capacity is generated in the friction engagement element. The slip engagement state means an engagement state in which there is a rotational speed difference (slip) between the engagement members of the friction engagement element. The direct engagement state means an engagement state in which there is no rotational speed difference (slip) between the engagement members of the friction engagement element. In addition, a non-direct engagement state means an engagement state other then the direct engagement state and includes the disengaged state and the slip engagement state.

Note that there are cases in which transmission torque capacity is generated in the friction engagement element due to a draw between the engagement members (friction members) even in a case in which a request to generate transmission torque capacity is not provided by the control device 30. For example, even in a case in which the friction members are not pressed to each other by the piston, there are cases in which the friction members contact with each other and transmission torque capacity is generated due to a draw between the friction members. Thus, the term “disengaged state” also includes a state in which transmission torque capacity is generated due to a draw between the friction members in a case in which a request to generate the transmission torque capacity is not provided by the control device 30.

In the present embodiment, the disengaged state of the first engagement device CL1 means a state in which transmission torque capacity is not generated in the first engagement device CL1. The slip engagement state of the first engagement device CL1 means a state in which transmission torque capacity is generated in the first engagement device CL1 and there is a difference between the rotational speed of the engine E and the rotational speed ωm of the rotary electric machine MG. The direct engagement state of the first engagement device CL1 means a state in which transmission torque capacity is generated in the first engagement device CL1 and there is no difference between the rotational speed of the engine E and the rotational speed ωm of the rotary electric machine MG.

The disengaged state of the second engagement device CL2 means a state in which transmission torque capacity is not generated in the second engagement device CL2. The slip engagement state of the second engagement device CL2 means a state in which transmission torque capacity is generated in the second engagement device CL2 and there is a difference between the rotational speeds of the two engagement members of the second engagement device CL2. The direct engagement state of the second engagement device CL2 means a state in which transmission torque capacity is generated in the second engagement device CL2 and there is no difference between the rotational speeds of the two engagement members of the second engagement device CL2. In a case in which the second engagement device CL2 is a clutch, the difference in the rotational speed between the two engagement members is the difference between the rotational speed of the engagement member 70 on the rotary electric machine MG side and the rotational speed of the engagement member 71 on the wheels W side in relation to the second engagement device CL2. In a case in which the second engagement device CL2 is a brake, the difference in the rotational speed between the two engagement members is the difference between the rotational speed (i.e., zero) of the engagement member on the non-rotatable member side such as a case and the rotational speed of the engagement member on the rotary electric machine MG and wheels W side. Hereinafter, a case in which the second engagement device CL2 is a clutch is exemplified.

2. Configuration of Hydraulic Control System

A hydraulic control system of the vehicle drive device 1 includes a hydraulic pressure control device PC that regulates the hydraulic pressure of hydraulic oil that is supplied from an oil pump to a predetermined pressure. The oil pump is driven by a driving force source of the vehicle or an exclusive motor. Detailed explanation is not provided here. However, note that the hydraulic pressure control device PC regulates the extent of the opening of one or more regulating valves based on a signal pressure from a linear solenoid valve for hydraulic pressure regulation to regulate the amount of the hydraulic oil that is drained from the one or more regulating valves and to regulate the hydraulic pressure of the hydraulic oil to one or more predetermined pressures. The hydraulic oil regulated to the predetermined pressures is supplied to the speed change mechanism TM, the respective friction engagement elements of the first engagement device CL1 and the second engagement device CL2, etc. at the respective required pressure levels.

3. Configuration of Control Device

Next, the configurations of the control device 30 and the engine control device 31 that controls the vehicle drive device 1 are explained with reference to FIG. 2.

The control units 32 to 34 in the control device 30 and the engine control device 31 each include, as a core member, an arithmetic processing device such as a CPU, etc., and include a storage device such as a RAM (random access memory) capable of reading and writing data from and into the arithmetic processing device, a ROM (read only memory) capable of reading data from the arithmetic processing device, etc. Respective function sections 41 to 47, etc. in the control device 30 are configured by software (program) stored in the ROM in the control device or separately provided hardware, or both. The control units 32 to 34 in the control device 30 and the engine control device 31 are configured to communicate with each other, and share various kinds of information such as detected information of sensors and control parameters, etc. and perform cooperative control, to realize the functions of the respective function sections 41 to 47.

In addition, the vehicle drive device 1 includes sensors Se1 to Se3. Electric signals outputted from the respective sensors are inputted to the control device 30 and the engine control device 31. The control device 30 and the engine control device 31 calculate the detected information of the respective sensors based on the inputted electric signals.

The input rotational speed sensor Se1 is a sensor that detects the rotational speed of the input shaft I and the intermediate shaft M. The input shaft I and the intermediate shaft M are drivingly coupled to the rotor of the rotary electric machine MG in an integrated manner. Therefore, the rotary electric machine control unit 32 detects the rotational speed ωm (angular speed) of the rotary electric machine MG and the rotational speed of the input shaft I and the intermediate shaft M based on the inputted signals of the input rotational speed sensor Se1. The output rotational speed sensor Se2 is a sensor that detects the rotational speed of the output shaft O. The power transmission control unit 33 detects the rotational speed (angular speed) of the output shaft O based on the inputted signals of the output rotational speed sensor Se2. In addition, the rotational speed of the output shaft O is proportional to the vehicle speed. Therefore, the power transmission control unit 33 calculates the vehicle speed based on the inputted signals of the output rotational speed sensor Se2. The engine rotational speed sensor Se3 is a sensor that detects the rotational speed of the engine output shaft Eo (engine E). The engine control device 31 detects the rotational speed (angular speed) of the engine E based on the inputted signals of the engine rotational speed sensor Se3.

3-1. Engine Control Device 31

The engine control device 31 includes an engine control section 41 that performs operation control for the engine E. In the present embodiment, in a case in which engine required torque is requested by the vehicle control unit 34, the engine control section 41 sets, as an output torque request value, the engine required torque requested by the vehicle control unit 34, and performs torque control that causes the engine E to output the torque of the output torque request value. In addition, in a case in which a request to start combustion of the engine is provided, the engine control device 31 determines that the combustion start of the engine E has been requested, and performs control that starts the combustion of the engine E by starting a fuel supply to the engine E, an ignition of the engine E, etc.

3-2. Power Transmission Control Unit 33

The power transmission control unit 33 includes a speed change mechanism control section 43 that performs control for the speed change mechanism TM, a first engagement device control section 44 that performs control for the first engagement device CL1, and a second engagement device control section 45 that performs control for the second engagement device CL2 during the start control of the engine E.

3-2-1. Speed Change Mechanism Control Section 43

The speed change mechanism control section 43 performs control that establishes each shift speed in the speed change mechanism TM. The speed change mechanism control section 43 determines a target shift speed in the speed change mechanism TM based on sensor detected information such as a vehicle speed, an extent of opening of an accelerator, a shift position, etc. The speed change mechanism control section 43 controls the hydraulic pressure that is supplied to a plurality of engagement devices provided in the speed change mechanism TM through the hydraulic pressure control device PC to engage or disengage the respective engagement devices and establish the target shift speed in the speed change mechanism TM. Specifically, the speed change mechanism control section 43 provides a request for a target hydraulic pressure (request pressure) for each engagement device to the hydraulic pressure control device PC and supplies the hydraulic pressure of the requested target hydraulic pressure (request pressure) to each engagement device.

3-2-2. First Engagement Device Control Section 44

The first engagement device control section 44 controls the engagement state of the first engagement device CL1. In the present embodiment, the first engagement device control section 44 controls the hydraulic pressure that is supplied to the first engagement device CL1 through the hydraulic pressure control device PC so as to coincide with a first target torque capacity requested by the vehicle control unit 34. Specifically, the first engagement device control section 44 provides a request for a target hydraulic pressure (request pressure) that is set based on the first target torque capacity to the hydraulic pressure control device PC. The hydraulic pressure control device PC supplies the hydraulic pressure of the requested target hydraulic pressure (request pressure) to the first engagement device CL1.

3-2-3. Second Engagement Device Control Section 45

The second engagement device control section 45 controls the engagement state of the second engagement device CL2 during the start control of the engine E. In the present embodiment, the second engagement device control section 45 controls the hydraulic pressure that is supplied to the second engagement device CL2 through the hydraulic pressure control device PC such that the transmission torque capacity of the second engagement device CL2 coincides with a second target torque capacity requested by the vehicle control unit 34. Specifically, the second engagement device control section 45 provides a request for a target hydraulic pressure (request pressure) that is set based on the second target torque capacity to the hydraulic pressure control device PC. The hydraulic pressure control device PC supplies the hydraulic pressure of the requested target hydraulic pressure (request pressure) to the second engagement device CL2.

In the present embodiment, the second engagement device CL2 is one of a single or a plurality of engagement devices that establish each shift speed in the speed change mechanism TM. The engagement device of the speed change mechanism TM utilized as the second engagement device CL2 may be changed according to the established shift speed, or may be the same engagement device.

3-3. Rotary Electric Machine Control Unit 32

The rotary electric machine control unit 32 includes a rotary electric machine control section 42 that performs operation control for the rotary electric machine MG. In the present embodiment, when rotary electric machine required torque is requested by the vehicle control unit 34, the rotary electric machine control section 42 sets, as an output torque request value, rotary electric machine required torque Tmo requested by the vehicle control unit 34 and controls the rotary electric machine MG so as to output the torque of the output torque request value. Specifically, the rotary electric machine control section 42 controls output torque Tm of the rotary electric machine MG through on-off control for a plurality of switching elements provided in the inverter.

3-4. Vehicle Control Unit 34

The vehicle control unit 34 includes a function section that performs control that integrates, as a whole vehicle, various kinds of torque control performed with respect to the engine E, the rotary electric machine MG, the speed change mechanism TM, the first engagement device CL1, the second engagement device CL2, etc., the engagement control for the respective engagement devices, etc.

The vehicle control unit 34 calculates, in accordance with the extent of opening of the accelerator, the vehicle speed, the amount of electric power stored in the battery, etc., torque required to drive the wheels W, that is, vehicle required torque Tr that is a target driving force that is transmitted from the intermediate shaft M to the output shaft O, and determines a drive mode of the engine E and the rotary electric machine MG. The vehicle control unit 34 is a function section that performs integrated control by calculating the engine required torque that is output torque required of the engine E, the rotary electric machine required torque Tmo that is output torque required of the rotary electric machine MG, the first target torque capacity that is transmission torque capacity required of the first engagement device CL1, the second target torque capacity that is transmission torque capacity required of the second engagement device CL2, and providing requests for the calculated values to the other control units 32 and 33 and the engine control device 31.

In the present embodiment, the vehicle control unit 34 includes the start control section 46 that performs the start control for the engine E and the direct rotational speed control section 47 that performs direct rotational speed control.

Hereinafter, the start control section 46 and the direct rotational speed control section 47 are explained in detail.

3-4-1. Start Control Section 46

The start control section 46 is a function section that performs the start control for the engine E that increases the rotational speed of the engine E using the rotational driving force of the rotary electric machine MG in a case in which a request to start the engine E is provided while the first engagement device CL1 is in the disengaged state and the second engagement device CL2 is in the direct engagement state, as shown in the timing chart of FIG. 3.

As mentioned above, after a request to start the engine E is provided, the start control section 46 starts the first transition control that causes the first engagement device CL1 to transition from the disengaged engagement state to the slip engagement state and the second transition control that causes the second engagement device CL2 to transition from the direct engagement state to the slip engagement state. Before the first engagement device CL1 transitions from the disengaged state to the slip engagement state, the start control section 46 starts the rotational speed control that controls the rotary electric machine MG such that the rotational speed of the rotary electric machine MG achieves the target rotational speed. Thereafter, when the second engagement device CL2 is brought into a predetermined slip engagement state, or when the change amount ΔT in the decrease direction of the output torque caused by the rotational speed control becomes equal to or greater than a predetermined value, the start control section 46 determines that the second engagement device CL2 has transitioned from the direct engagement state to the slip engagement state. After such a determination, the start control section 46 causes the first engagement device CL1 to transition from the slip engagement state to the direct engagement state.

<Problem in Start Control>

At the time of changing the engagement state of the first engagement device CL1 to start the engine E, there is a possibility that the torque transmitted from the first engagement device CL1 to the rotary electric machine MG suddenly changes and torque shock is transmitted to the wheels W.

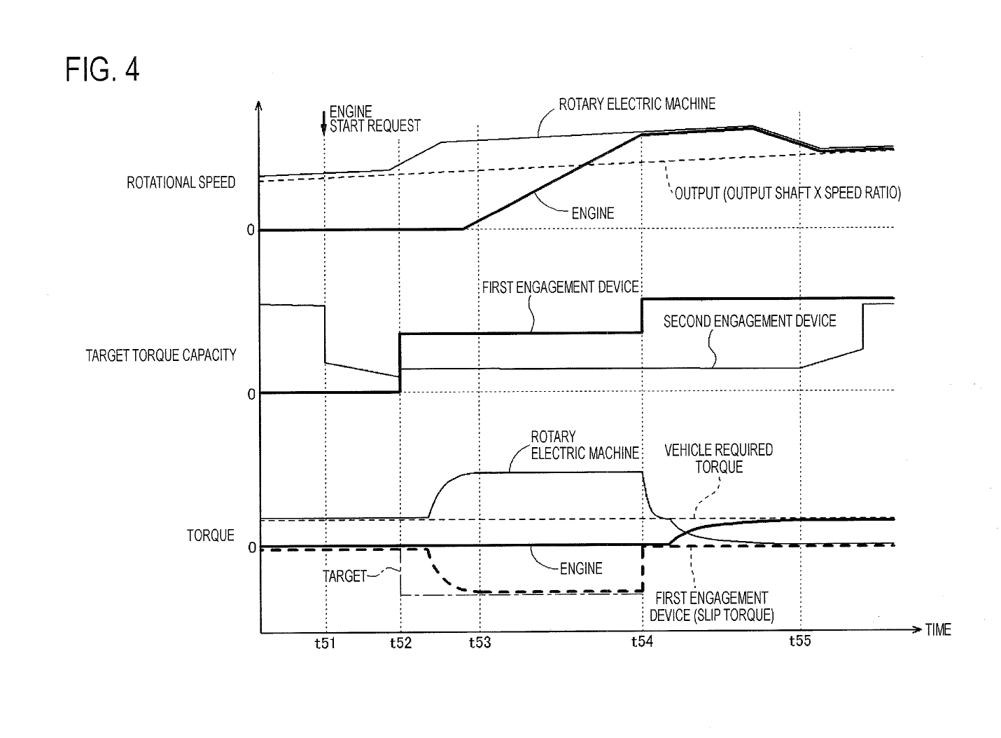

Therefore, as shown in the timing chart of FIG. 4, conventional start control is configured to change the engagement state of the first engagement device CL1 after the second engagement device CL2, which is arranged between the first engagement device CL1 and the wheels W, transitions from the direct engagement state to the slip engagement state and while the second engagement device CL2 is in the slip engagement state (time t52 to t55). When the second engagement device CL2 is brought into the slip engagement state, the torque transmitted from the second engagement device CL2 to the wheels W becomes slip torque of the magnitude of the transmission torque capacity of the second engagement device CL2. Thereby, even in a case in which the torque shock is transmitted from the first engagement device CL1 to the rotary electric machine MG because of the change in the engagement state of the first engagement device CL1, it is possible to prevent the torque shock from being transmitted from the rotary electric machine MG to the wheels W through the second engagement device CL2. On the other hand, the conventional start control is configured to cause the first engagement device CL1 to transition from the disengaged state to the slip engagement state after the second engagement device CL2 transitions from the direct engagement state to the slip engagement state and while the second engagement device CL2 (subsequent to time t52). Therefore, it is necessary to wait until the second engagement device CL2 is brought into the slip engagement state before the transition of the first engagement device CL1 to the slip engagement state. Due to such a waiting time, the time period from a request to start the engine E until the rotational speed of the engine E starts to increase becomes long. Thus, there has been a problem that the time period of the start control of the engine E becomes long.

<Purpose of Present Invention>

On the other hand, the start control according to the present invention is configured to start transition control that causes the first engagement device CL1 to transition to the slip engagement state before the second engagement device CL2 transitions to the slip engagement state. Thus, there is no waiting time until the second engagement device CL2 transitions to the slip engagement state, unlike the conventional start control. Therefore, the period from a request to start the engine E until the rotational speed of the engine E starts to increase is shortened by such a waiting time, which makes it possible to shorten the time period of the start control of the engine E.

In addition, in the start control according to the present invention, even in a case in which the torque shock is transmitted from the first engagement device CL1 to the rotary electric machine MG because of the change in the transmission torque capacity of the first engagement device CL1, the output torque of the rotary electric machine MG is controlled so as to cancel the torque shock by executing the rotational speed control. Therefore, it is possible to prevent the torque shock from being transmitted from the rotary electric machine MG to the wheels W through the second engagement device CL2 in the direct engagement state.

Hereinafter, the start control is explained in detail with reference to the timing chart shown in FIG. 3.

The start control section 46 starts a series of start control (time t11) in a case in which the start condition of the engine E is satisfied, for example, the extent of opening of the accelerator is increased or the amount of electric power stored in the battery is decreased in a state in which the combustion of the engine E is off and the rotary electric machine MG is rotating, and a request to start the engine E is provided.

In the present embodiment, the start control section 46 is configured to perform sequence control that switches the control contents by switching the control phase in accordance with operations and conditions that are previously defined.

3-4-1-1. Phase 1

After a request to start the engine E is provided, the start control section 46 starts the first transition control that causes the first engagement device CL1 to transition from the disengaged engagement state to the slip engagement state and the second transition control that causes the second engagement device CL2 to transition from the direct engagement state to the slip engagement state. Before the first engagement device CL1 transitions from the disengaged state to the slip engagement state, the start control section 46 starts the rotational speed control that controls the rotary electric machine MG such that the rotational speed of the rotary electric machine MG achieves the target rotational speed.

Starting the first transition control here means providing a request to generate transmission torque capacity in the first engagement device CL1. In addition, starting the second transition control means providing a request to gradually decrease the transmission torque capacity generated in the second engagement device CL2 until the difference in the rotational speed between the two engagement members of the second engagement device CL2 is generated.

In the present embodiment, when a request to start the engine E is provided (time t11), the start control section 46 sets the control phase to phase 1. Thereafter, the start control section 46 starts the rotational speed control for the rotary electric machine MG. In the present embodiment, the start control section 46 is configured to set, as the target rotational speed, a direct target rotational speed, which is explained later, before it is determined that the second engagement device CL2 has transitioned from the direct engagement state to the slip engagement state. The rotational speed control that sets the direct target rotational speed as the target rotational speed in such a manner is referred to as “direct rotational speed control.” The direct rotational speed control section 47 is configured to estimate transmission path input torque Tin that is torque inputted to the power transmission path 2 based on the change in the rotational speed ωm of the rotary electric machine MG, estimate external input torque Tw inputted from the wheels W to the power transmission path 2 by subtracting at least the output torque Tm of the rotary electric machine from the estimated transmission path input torque Tine, and calculate the direct target rotational speed ωmo based on the estimated external input torque Twre and the vehicle required torque Tr that is torque required to drive the wheels W. The details are described later.

In addition, when a request to start the engine E is provided (time t11), the start control section 46 starts the first transition control that causes the first engagement device CL1 to transition from the disengaged engagement state to the slip engagement state. In addition, the start control section 46 starts the second transition control that causes the second engagement device CL2 to transition from the direct engagement state to the slip engagement state. Note that the start control section 46 keeps the combustion of the engine E off at the time of starting phase 1.

<Setting of Target Torque Capacity of First Engagement Device CL1>

In the present embodiment, when a request to start the engine E is provided (time t11), the start control section 46 increases the first target torque capacity of the first engagement device CL1 from zero to a predetermined starting torque. The starting torque is set to torque that is greater than an absolute value of negative torque of the engine E, such as friction torque of the engine E, so as to be able to increase the rotational speed of the engine E.

In the present embodiment, the first target torque capacity is configured to be increased from zero in a stepped manner. In a case in which the first target torque capacity is rapidly increased, the transmission torque capacity of the first engagement device CL1 is rapidly increased, which could increase the torque shock due to an estimate error in the first transmission torque capacity. However, in the present embodiment, it is possible to reduce the torque shock transmitted to the wheels W through the direct rotational speed control. Conversely, because it can be suppressed that the torque shock is transmitted to the wheels W through the direction rotational speed control, an increase speed of the transmission torque capacity of the first engagement device CL1 can be accelerated by changing the first target torque capacity in a stepped manner. Thereby, the transition of the first engagement device CL1 to the slip engagement state can be accelerated and the time to start the engine E can be shortened.

<Slip Torque of First Engagement Device CL1>

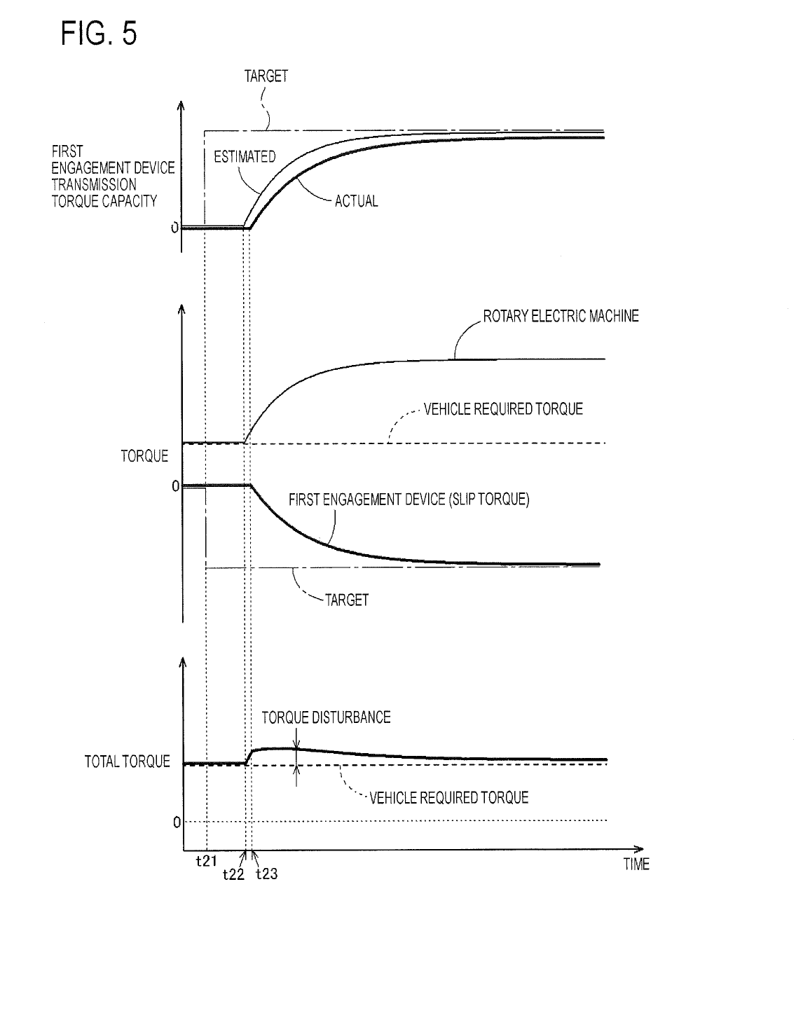

The actual transmission torque capacity of the first engagement device CL1 changes with a response lag with respect to the first target torque capacity, as shown in the example of FIG. 5. After the first target torque capacity is increased from zero, a dead time is generated until the oil is filled in the hydraulic cylinder of the first engagement device CL1 and the transmission torque capacity starts to increase from zero. In addition, after the dead time passes, the transmission torque capacity increases with a first-order lag. That is, the response lag characteristics of the transmission torque capacity can be modeled with the dead time lag and the first-order lag.

The start control section 46 is configured to estimate the transmission torque capacity (first transmission torque capacity) of the first engagement device CL1 based on the first target torque capacity or the target hydraulic pressure using the response lag characteristics of the transmission torque capacity.

In the present embodiment, the start control section 46 is configured to estimate the transmission torque capacity of the first engagement device CL1 by performing dead time lag processing and first-order lag filter processing with respect to the first target torque capacity. The dead time and a first-order lag filter coefficient (time constant) are set to values that are previously set. Alternatively, the start control section 46 may be configured to include a transient behavior map in which a relation between the lapse time after the first target torque capacity is increased from zero and the change in the transmission torque capacity of the first engagement device CL1 is previously set, and to estimate the transmission torque capacity of the first engagement device CL1 based on the lapse time after the first target torque capacity is increased from zero using the transient behavior map.

The start control section 46 calculates, based on the estimated first transmission torque capacity, an estimated value of first slip torque Tf (estimated first slip torque Tfe) that is transmitted from the first engagement device CL1 to the rotary electric machine MG with dynamic friction. During the start control, the torque is transmitted from the rotary electric machine MG to the engine E in relation to the first engagement device CL1. Therefore, the start control section 46 sets, as the estimated first slip torque Tfe, a value acquired by multiplying the estimated first transmission torque capacity by a negative sign (−1).

<Setting of Rotary Electric Machine Required Torque>

During the start control, the torque that is transmitted from the rotary electric machine MG to the wheels W decreases by the absolute value of the first slip torque. To compensate the decrease by the absolute value of the first slip torque in a feedforward manner, the start control section 46 is configured to set basic rotary electric machine required torque Tb based on the vehicle required torque Tr and the estimated first slip torque Tfe that is an estimated value of the transmission torque of the first engagement device CL1. Specifically, the start control section 46 is configured to set the basic rotary electric machine required torque Tb by adding the absolute value of the estimated first slip torque Tfe to the vehicle required torque Tr.

However, as shown in the example of FIG. 5, in a case in which an estimated error is caused in the estimated first transmission torque capacity (estimated first slip torque Tfe), the total amount of torque of the output torque Tm of the rotary electric machine MG and the first slip torque Tf fluctuates from the vehicle required torque and the torque shock is caused. However, the first slip torque Tf increases from zero with the first-order lag. Therefore, the torque shock does not have a waveform changing in a stepped manner but a waveform increasing gradually. Note that a case is exemplified in FIG. 5, in which the estimated error is caused because of the setting errors in the dead time, the first-order lag filter coefficient, and gain.

In the present embodiment, in order to reduce the torque shock transmitted to the wheels W, the start control section 46 is configured to calculate the rotary electric machine required torque Tmo by correcting the basic rotary electric machine required torque Tb based on rotational control torque request Tp calculated through the direct rotational speed control. The details of the direct rotational speed control are described later.

<Combustion Start of Engine E and Start of 0 Nm Control>

When the transmission torque capacity of the first engagement device CL1 exceeds the absolute value of the friction torque of the engine E, the rotational speed of the engine E starts to increase. In the present embodiment, when the rotational speed of the engine E becomes equal to or higher than a predetermined rotational speed (time t12), the start control section 46 provides a request for combustion start of the engine E to the engine control device 31 to start the combustion of the engine E. Also, after the combustion of the engine E starts, the start control section 46 starts 0 Nm control that controls the output torque of the engine E so as to be zero.

In addition, the start control section 46 may be configured to execute the combustion start of the engine E during the time when the rotational speed of the engine E is equal to or higher than the rotational speed at which the engine E is capable of starting the combustion and at least one of the first engagement device CL1 and the second engagement device CL2 is in the slip engagement state. Even in such a configuration, it is possible to prevent the fluctuation in the output torque of the engine E caused by the combustion start of the engine E from being transmitted to the wheels W because the first engagement device CL1 or the second engagement device CL2 is in the slip engagement state. For example, the combustion start of the engine E may be executed after the second engagement device CL2 transitions from the direct engagement state to the slip engagement state. In addition, in connection with such a case, the starting time of the increase in the rotational speed of the engine E or the starting time of the increase in the transmission torque capacity of the first engagement device CL1 may be after the second engagement device CL2 transitions from the direct engagement state to the slip engagement state. Even in such a case, it is possible to prevent the torque shock due to the change in the transmission torque capacity of the first engagement device CL1 from being transmitted to the wheels W because the second engagement device CL2 is in the slip engagement state.

<Second Transition Control of Second Engagement Device CL2>

In the present embodiment, when a request to start the engine E is provided (time t11), the start control section 46 starts the second transition control that causes the second engagement device CL2 to transition from the direct engagement state to the slip engagement state. In the present embodiment, the start control section 46 starts, as the second transition control, sweep-down that gradually decreases the second target torque capacity from a full engagement capacity. In the present embodiment, the start control section 46 is configured to decrease, in a stepped manner, the second target torque capacity from the full engagement capacity to a predetermined transmission torque capacity, at which the second engagement device does not transition to the slip engagement state, at the time of starting the sweep-down, and thereafter, gradually decrease the second target torque capacity. The full engagement capacity here is the transmission torque capacity at which an engagement state without slip can be maintained even in a case in which the torque transmitted from a driving force source to the second engagement device CL2 fluctuates. In the present embodiment, the start control section 46 is configured to decrease, in a stepped manner, the second target torque capacity from the full engagement capacity to the capacity that is by a predetermined capacity greater than the transmission torque capacity that corresponds to the vehicle required torque, and thereafter, gradually decrease the second target torque capacity at a predetermined angle.

When the second target torque capacity is gradually decreased through the sweep-down and the transmission torque capacity of the second engagement device CL2 falls below the torque that is transmitted from the rotary electric machine MG to the second engagement device CL2, slip starts to occur between the engagement members of the second engagement device CL2 (time t13).

The second target torque capacity continues to be gradually decreased until it is determined that the second engagement device CL2 has been brought into the slip engagement state. Therefore, the torque (vehicle transmission torque) transmitted from the rotary electric machine MG to the wheels W through the second engagement device CL2 gradually decreases from the vehicle required torque Tr (subsequent to time t13).

Therefore, the rotational speed ωm of the rotary electric machine MG tries to increase with respect to the output rotational speed that is acquired by multiplying the rotational speed of the output shaft O by the speed ratio Kr. However, a rapid change in the rotational speed mm of the rotary electric machine MG is suppressed through the direct rotational speed control. Therefore, an increase in the rate of change of the rotational speed ωm of the rotary electric machine MG is suppressed (from time t13 to t14). At this time, in order to suppress the increase in the rotational speed ωm of the rotary electric machine MG, the rotational control torque request Tp gradually decreases as the vehicle transmission torque decreases.

In addition, the vehicle transmission torque that is transmitted from the rotary electric machine MG to the wheels W through the second engagement device CL2 decreases. Therefore, the rate of change of the rotational speed of the wheels W decreases.

After the second engagement device CL2 is brought into the slip engagement state, the rotational speed difference Δω1 between the rotational speed ωm of the rotary electric machine MG and the output rotational speed, which corresponds to the rotational difference between the engagement members of the second engagement device CL2, gradually increases (from time t13 to t14). Note that the increase in the rotational speed difference Δω1 during the direct rotational speed control is explained in detail in the section of the behavior of the direct rotational speed control.

3-4-1-2. Phase 2

When the second engagement device CL2 is brought into a predetermined slip engagement state, or when a change amount ΔT (absolute value) in the decrease direction of the output torque caused by the rotational speed control becomes equal to or greater than a predetermined value, the start control section 46 determines that the second engagement device CL2 has transitioned from the direct engagement state to the slip engagement state. After such a determination, the start control section 46 causes the first engagement device CL1 to transition from the slip engagement state to the direct engagement state.

In the present embodiment, the start control section 46 is configured to determine that the second engagement device CL2 has transitioned from the direct engagement state to the slip engagement state when the second engagement device CL2 is brought into a predetermined slip engagement state. When the second engagement device CL2 is brought into a predetermined slip engagement state means when the rotational speed difference that corresponds to the rotational speed difference between the engagement members of the second engagement device CL2, which is calculated based on the rotational speed ωm of the rotary electric machine MG and the rotational speed of the wheels W, becomes equal to or greater than a predetermined value. The start control section 46 is configured to determine that the second engagement device CL2 has transitioned from the direct engagement state to the slip engagement state when the rotational speed difference that corresponds to the rotational speed difference between the engagement members of the second engagement device CL2 becomes equal to or greater than the predetermined value. Note that the “predetermined value” in the present application is a value that is previously determined and may be a fixed value or a value that varies with a parameter.

As mentioned later, the rotational speed difference that corresponds to the rotational speed difference between the engagement members of the second engagement device CL2 is generated by the rotational speed of the wheels W falling below the rotational speed of the wheels W in a case in which the second engagement device CL2 is in the direct engagement state when the rotational speed ωm of the rotary electric machine MG is controlled so as to become the direct target rotational speed.

In the present embodiment, the start control section 46 is configured to calculate, as the rotational speed difference that corresponds to the rotational speed difference between engagement members of the second engagement device CL2, the rotational speed difference Δω1 between the rotational speed ωm of the rotary electric machine MG and the output rotational speed that is acquired by multiplying the rotational speed of the output shaft O as the rotational speed of the wheels W by the speed ratio Kr of the speed change mechanism TM.

Note that the start control section 46 may be configured to determine that the second engagement device has been brought into the slip engagement state when the change amount ΔT (absolute value) in the decrease direction of the rotational control torque request Tp that is a corrected value of the output torque by the direct rotational speed control becomes equal to or greater than a predetermined value. The change amount ΔT can be an amount (absolute value) of decrease from zero.

The start control section 46 is configured to, after it is determined that the second engagement device CL2 has transitioned from the direct engagement state to the slip engagement state, set, as the target rotational speed, the slip target rotational speed in place of the direct target rotational speed. The rotational speed control that sets the slip target rotational speed as the target rotational speed in such a manner is referred to as “slip rotational speed control.” The start control section 46 calculates, as the slip target rotational speed, the rotational speed that is by a predetermined value higher than the rotational speed ωm of the rotary electric machine MG in a case in which the second engagement device CL2 is in the direct engagement state and sets the calculated slip target rotational speed as the target rotational speed. Here, the rotational speed ωm of the rotary electric machine MG in a case in which the second engagement device CL2 is in the direct engagement state means the rotational speed ωm of the rotary electric machine MG in a case in which it is assumed that the second engagement device CL2 is brought into the direct engagement state in a situation in which the rotational speed of the output shaft O is the current rotational speed. In the present embodiment, the start control section 46 is configured to calculate, as the rotational speed ωm of the rotary electric machine MG in a case in which the second engagement device CL2 is in the direct engagement state, the output rotational speed acquired by multiplying the rotational speed of the output shaft O by the speed ratio Kr of the speed change mechanism TM.

In the present embodiment, when the rotational speed difference Δω1 between the rotational speed win of the rotary electric machine MG and the output rotational speed becomes equal to or greater than a predetermined rotational speed difference (time t14), the start control section 46 determines that the second engagement device CL2 has transitioned to the slip engagement state and changes the control phase from phase 1 to phase 2. The start control section 46 sets, as the target rotational speed, the slip target rotational speed in place of the direct target rotational speed and starts the slip rotational speed control (time t14). The start control section 46 terminates the sweep-down for the second target torque capacity of the second engagement device CL2 and starts torque control that sets the second target torque capacity to the vehicle required torque Tr (time t14). In addition, the start control section 46 maintains the 0 Nm control that controls the output torque of the engine E so as to be zero. In addition, the start control section 46 maintains the torque control that controls the first engagement device CL1 so as to be in the slip engagement state.

3-4-1-3. Phase 3

After the second engagement device CL2 transitions from the direct engagement state to the slip engagement state, the start control section 46 is configured to cause the first engagement device CL1 to transition from the slip engagement state to the direct engagement state. When the rotational speed difference Δω2 between the rotational speed ωm of the rotary electric machine MG and the rotational speed of the engine E becomes smaller than or equal to a predetermined value (time t15), the start control section 46 determines that the first engagement device CL1 has been brought into the direct engagement state and changes the control phase from phase 2 to phase 3.

The start control section 46 terminates the torque control for the first engagement device CL1 and increases the first target torque capacity from the starting torque to the full engagement capacity. The full engagement capacity here is the transmission torque capacity at which an engagement state without slip can be maintained even when the torque transmitted from a driving force source to the first engagement device CL1 fluctuates. In addition, the start control section 46 terminates the 0 Nm control for the engine E and starts the torque control that causes the engine E to output the torque that corresponds to the vehicle required torque Tr. The start control section 46 gradually decreases the target rotational speed of the rotary electric machine MG down to the output rotational speed to decrease the rotational speed ωm of the rotary electric machine MG down to the output rotational speed.

3-4-1-4. Phase 4

When the rotational speed difference Δω1 between the rotational speed ωm of the rotary electric machine MG and the output rotational speed becomes smaller than or equal to a predetermined value (time t16), the start control section 46 determines that second engagement device CL2 has been brought into the direct engagement state and changes the control phase from phase 3 to phase 4.

The start control section 46 starts sweep-up that gradually increases the second target torque capacity of the second engagement device CL2 up to the full engagement capacity. In addition, the start control section 46 terminates the rotational speed control for the rotary electric machine MG and starts the torque control that sets the rotary electric machine required torque in accordance with the vehicle required torque Tr. Here, the engine required torque and the rotary electric machine required torque are set such that the total of the engine required torque and the rotary electric machine required torque coincide with the vehicle required torque.

When the second target torque capacity increases up to the full engagement capacity (time t17), the start control section 46 terminates a series of start control.

3-4-1-5. Flow Chart of Start Control

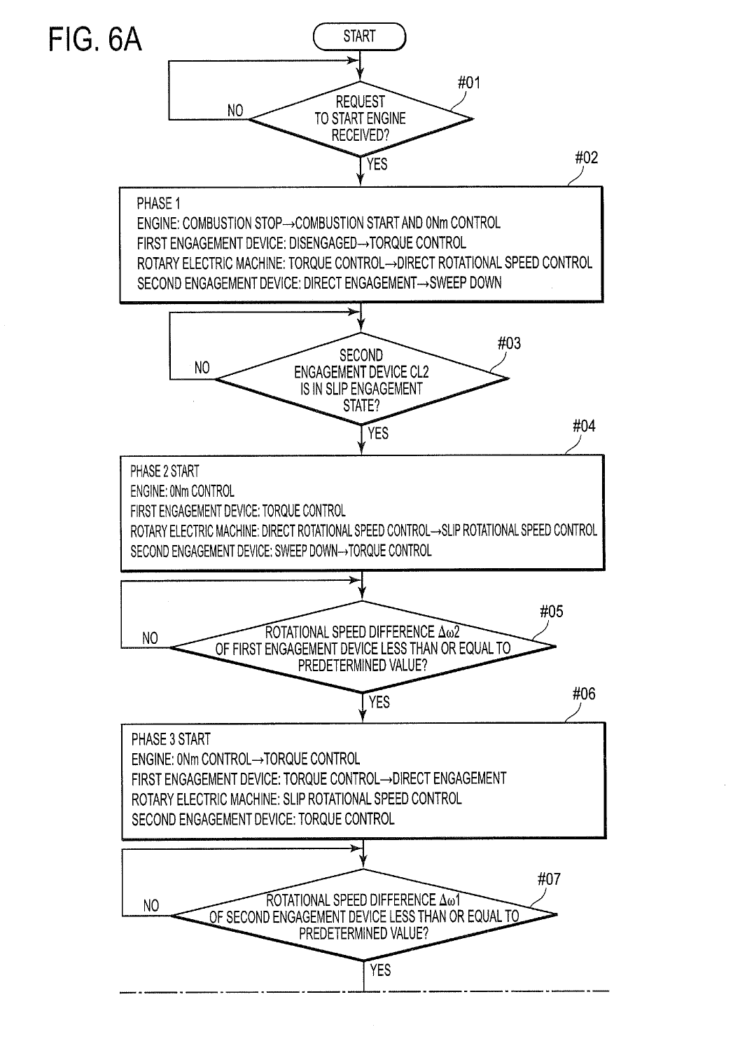

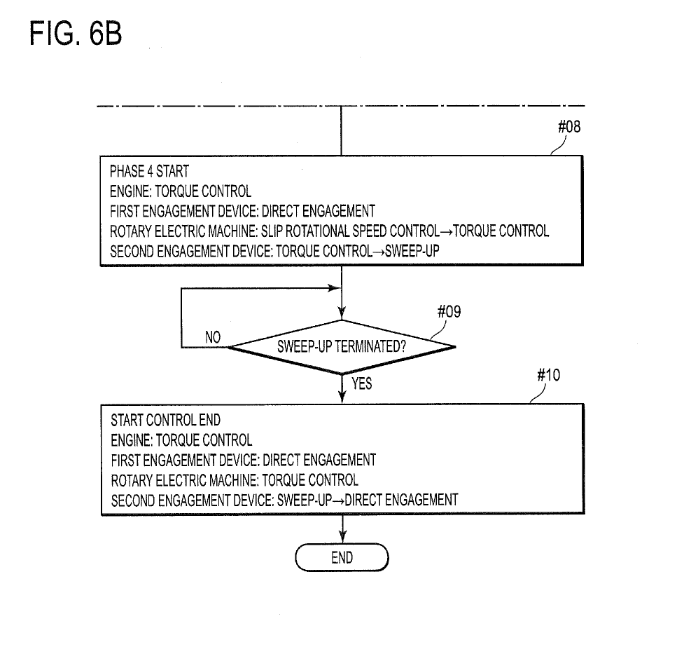

Next, the processing of the start control is explained with reference to the flow chart in FIG. 6. Initially, when a request to start the engine E is provided, the start control section 46 starts a series of start control (Step #01: YES). Then, the start control section 46 starts the control of phase 1 (Step #02). Specifically, the start control section 46 keeps the combustion of the engine E off at the time of starting phase 1, and when the rotational speed of the engine E increases up to a predetermined rotational speed, starts the combustion and the 0 Nm control. In addition, in order to cause the first engagement device CL1 to transition from the disengaged state to the slip engagement state, the start control section 46 starts the torque control, starts the direct rotational speed control for the rotary electric machine MG, and starts the sweep-down for the second target torque capacity of the second engagement device CL2 to gradually degrease the transmission torque capacity of the second engagement device CL2.

When it is determined that the second engagement device CL2 has been bought into the slip engagement state (Step #03: YES), the start control section 46 starts the control of phase 2 (Step #04). Specifically, the start control section 46: maintains the 0 Nm control for the engine E; maintains the torque control for the first engagement device CL1; terminates the direct rotational speed control and starts the slip rotational speed control for the rotary electric machine MG; and terminates the sweep-down and starts the torque control for the second engagement device CL2.

When the rotational speed difference Δω2 of the first engagement device CL1 becomes smaller than or equal to a predetermined value and it is determined that the first engagement device CL1 has transitioned to the direct engagement state (Step #05: YES), the start control section 46 starts the control of phase 3 (Step #06). Specifically, the start control section 46: terminates the 0 Nm control and starts the torque control for the engine E; terminates the torque control for the first engagement device CL1 and increases the first target torque capacity up to the full engagement capacity; maintains the slip rotational speed control for the rotary electric machine MG; and maintains the torque control for the second engagement device CL2.

When the rotational speed difference Δω1 of the second engagement device CL2 becomes smaller than or equal to a predetermined value and it is determined that the second engagement device CL2 has transitioned to the direct engagement (Step #07: YES), the start control section 46 starts phase 4 (Step #8). Specifically, the start control section 46: maintains the torque control for the engine E; maintains the direct engagement state of the first engagement device CL1; terminates the slip rotational speed control and starts torque control for the rotary electric machine MG; and increases the second target torque capacity of the second engagement device CL2 up to the full engagement capacity.

When the second target torque capacity of the second engagement device CL2 increases up to the full engagement capacity (Step #9: YES), the start control section 46 terminates a series of start control (Step #10).

3-4-2. Direct Rotational Speed Control Section 47

Next, the direct rotational speed control that is executed by the direct rotational speed control section 47 is explained in detail.

The direct rotational speed control section 47 is a function section that calculates the direct target rotational speed serving as the target rotational speed and controls the rotary electric machine MG such that the rotational speed ωm of the rotary electric machine MG achieves the direct target rotational speed.

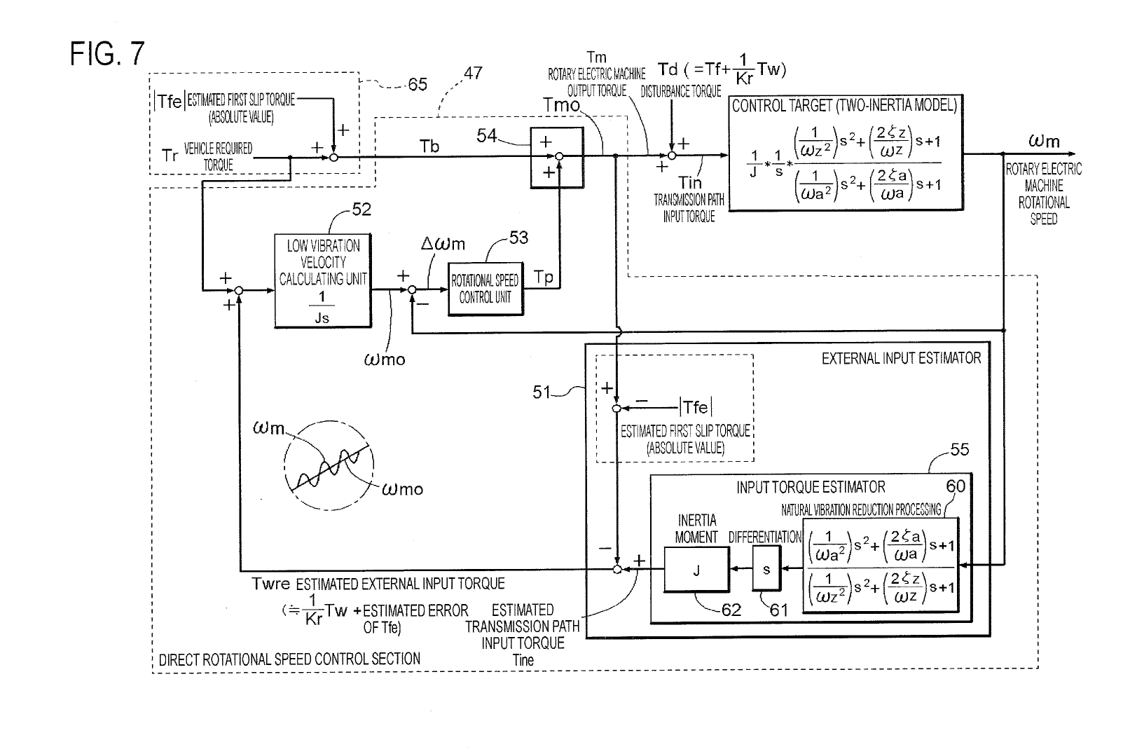

In the present embodiment, as shown in FIG. 7, the direct rotational speed control section 47 includes an external input estimator 51 that estimates the transmission path input torque Tin that is torque inputted to the power transmission path 2 based on the change in the rotational speed ωm of the rotary electric machine MG and estimates the external input torque Tw inputted from the wheels W to the power transmission path 2 by subtracting at least the output torque Tm of the rotary electric machine from the estimated transmission path input torque Tine. In addition, the direct rotational speed control section 47 includes a low vibration velocity calculating unit 52 that calculates the direct target rotational speed ωmo based on the estimated external input torque Twre and the vehicle required torque Tr that is torque required to drive the wheels W. The direct rotational speed control section 47 includes a rotational speed control unit 53 that calculates the rotational control torque request Tp that causes the rotational speed ωm of the rotary electric machine MG to approach the direct target rotational speed ωmo, and controls the output torque Tm of the rotary electric machine MG using the rotational control torque request Tp.

3-4-2-1. Modeling of Power Transmission Path 2 as Two-Inertia System

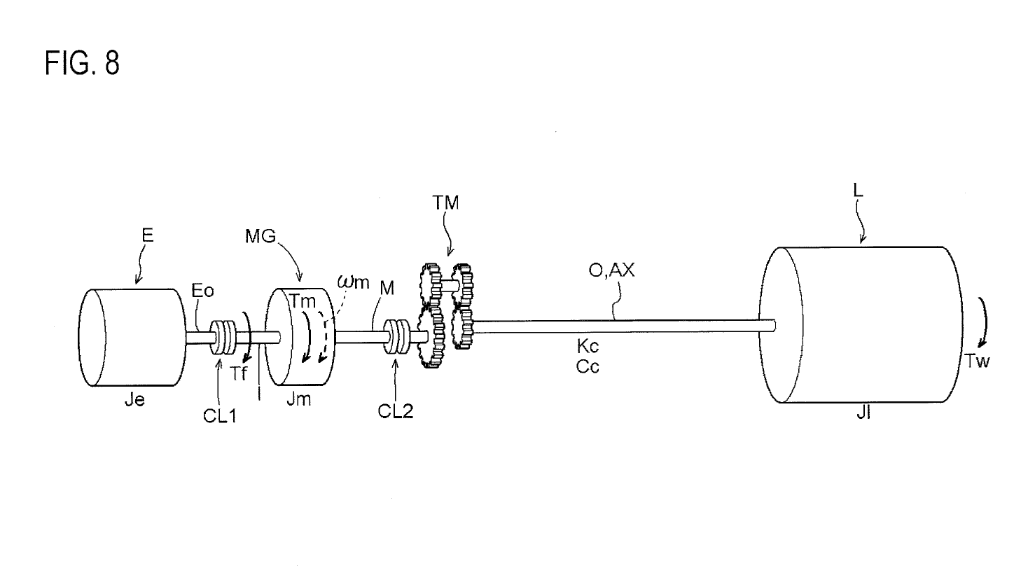

Initially, FIG. 8 shows a model of the power transmission path 2 that serves as a base for the direct rotational speed control. The power transmission path 2 is modeled as a shaft torsional vibration system. The rotary electric machine MG is drivingly coupled to the engine E when the first engagement device CL1 is in the direct engagement state, and is drivingly coupled to the speed change mechanism TM when the second engagement device CL2 is in the direct engagement state. The speed change mechanism TM is drivingly coupled to the vehicle that is a load L via the output shaft O and the axle shafts AX. The speed change mechanism TM shifts the rotational speed between the intermediate shaft M and the output shaft O at the speed ratio Kr and converts the torque. Note that the output shaft O and the axle shafts AX are referred to collectively as output shaft.

The engine E, the rotary electric machine MG, and the load L (vehicle) are modeled as rigid bodies having the respective inertia moments (inertia) Je, Jm, and Jl. The respective rigid bodies are drivingly coupled via the shafts of the engine output shaft Eo, the input shaft I, the intermediate shaft M, and the output shaft. In a case in which the first engagement device CL1 is in the slip engagement state and the second engagement device CL2 is in the direct engagement state, as the case of phase 1 in the start control, the power transmission path 2 can be modeled as a two-inertia system of the rotary electric machine MG and the load (vehicle).

Tf denotes the slip torque (first slip torque) transmitted from the first engagement device CL1 to the rotary electric machine MG when the first engagement device CL1 is in the slip engagement state. Tm denotes the output torque that the rotary electric machine MG outputs, and ωm denotes the rotational speed ωm (angular speed) of the rotary electric machine MG. In addition, Tw denotes the external input torque such as braking torque and travel resistant torque, e.g., slope resistance, air resistance, tire friction resistance, which are inputted from the wheels W to the power transmission path 2. Kc denotes a torsional spring constant of the output shaft, and Cc denotes a viscous friction coefficient of the output shaft.

3-4-2-2. Transfer Function of Two-Inertia System Model

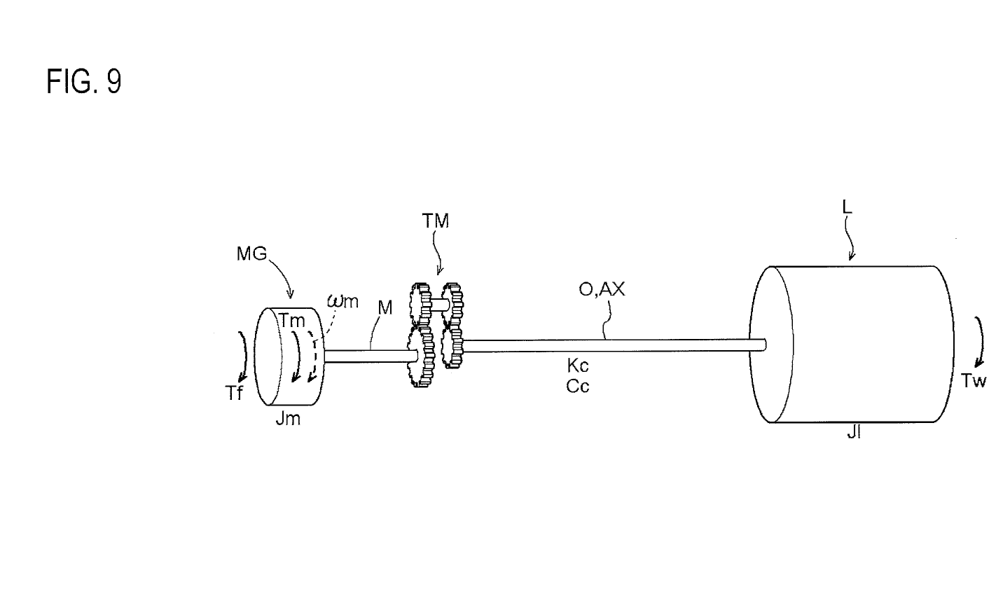

When the power transmission path 2 is modeled as the two-inertia system as shown in FIG. 9, the transfer function P (s) from the output torque Tm of the rotary electric machine MG, the first slip torque Tf, and the external input torque Tw to the rotational speed ωm of the rotary electric machine MG is expressed as Equation (1).

$$\begin{matrix}[ Equation 1 ] & \\ ω m ( s ) = P ( s ) Tin ( s ) \\ P ( s ) = \frac{1}{J} \frac{1}{s} \frac{( 1 / ω {z}^{2} ) {s}^{2} + 2 ( ζ z / ω z ) s + 1}{( 1 / ω {a}^{2} ) {s}^{2} + 2 ( ζ a / ω a ) s + 1} \\ Tin ( s ) = Tm ( s ) + Tf ( s ) + \frac{1}{Kr} Tw ( s ) & ( 1 )\end{matrix}$$

Here, Tin denotes a total value of the output torque Tm of the rotary electric machine MG, the first slip torque Tf, and the external input torque Tw, which are inputted to the power transmission path 2. The external input torque Tw have an influence on the rotational speed ωm of the rotary electric machine MG by the magnitude acquired by dividing the external input torque Tw by the speed ratio Kr. J denotes an inertia moment of the entire power transmission path 2. ωa denotes a resonant frequency of power transmission path 2, ζa denotes a resonance point damping rate, ωz denotes an antiresonant frequency of the power transmission path 2, and ζz denotes an antiresonance point damping rate. These are expressed using the torsional spring constant Kc and the viscous friction coefficient Cc of the output shaft, the inertia moment Jl of the load (vehicle), the inertia moment Jm of the rotary electric machine MG, and the speed ratio Kr, as Equation (2).

The speed ratio Kr changes in accordance with the shift speed established in the speed change mechanism TM. Therefore, the inertia moment J of the entire power transmission path 2 and the resonant frequency ωa change in accordance with the speed ratio Kr.

$$\begin{matrix}[ Equation 2 ] & \\ J = \frac{1}{{Kr}^{2}} Jl + Jm \\ \begin{matrix}ω a = \sqrt{Kc ( \frac{1}{Jl} + \frac{1}{{Kr}^{2} Jm} )} & ζ a = \frac{Cc ω a}{2 Kc} \\ ω z = \sqrt{\frac{Kc}{Jl}} & ζ z = \frac{Cc ω z}{2 Kc}\end{matrix} & ( 2 )\end{matrix}$$

3-4-2-3. External Input Estimator

<Estimation of Transmission Path Input Torque>

It can be understood from Equation (1) that the rotational speed ωm of the rotary electric machine MG is the rotational speed acquired by dividing the transmission path input torque Tin by the inertia moment J of the entire power transmission path 2, integrating, and thereafter adding vibrational component of the resonant frequency ωa that is a natural frequency of the power transmission path 2. Thus, in order to estimate the transmission path input torque Tin based on the rotational speed ωm of the rotary electric machine MG, it is necessary to reduce at least the vibrational component of the resonant frequency ωa of the rotational speed ωm of the rotary electric machine MG. In addition, it is also understood that transmission path input torque Tin can be estimated by, in addition to the reduction of the vibrational component, performing differential arithmetic processing and multiplying the inertia moment J of the entire power transmission path 2.

Thus, as described above, the external input estimator 51 is configured to estimate the transmission path input torque Tin that is torque inputted to the power transmission path 2, based on the change in the rotational speed ωm of the rotary electric machine MG after the vibrational component of the resonant frequency of the power transmission path 2 is reduced.

In the present embodiment, as shown in FIG. 7, an input torque estimator 55 provided in the external input estimator 51 is configured to calculate an estimated value Tine of the transmission path input torque Tin by performing, with respect to the rotational speed ωm of the rotary electric machine MG, natural vibration reduction processing 60 that is signal processing to reduce at least the vibrational component of the power transmission path 2, differential arithmetic processing 61, and multiplication processing 62 of the inertia moment J of the entire power transmission path 2. In addition, the processing order of the natural vibration reduction processing 60, the multiplication processing 62 of the inertia moment, and the differential arithmetic processing 61 may be changed as desired.

In the example shown in FIG. 7, the input torque estimator 55 is set to perform signal processing that is set based on inverse transfer characteristics 1/P (s) of the transfer function P (s) that expresses the transfer characteristic from the output torque Tm of the rotary electric machine MG to the rotational speed ωm of the rotary electric machine MG.

In the present example, the natural vibration reduction processing 60 is set to transfer function Pr (s) of Equation (3) based on the inverse characteristics of the two-inertia vibrational characteristics.

$$\begin{matrix}[ Equation 3 ] & \\ Pr ( s ) = \frac{( 1 / ω {a}^{2} ) {s}^{2} + 2 ( ζ a / ω a ) s + 1}{( 1 / ω {z}^{2} ) {s}^{2} + 2 ( ζ z / ω z ) s + 1} & ( 3 )\end{matrix}$$

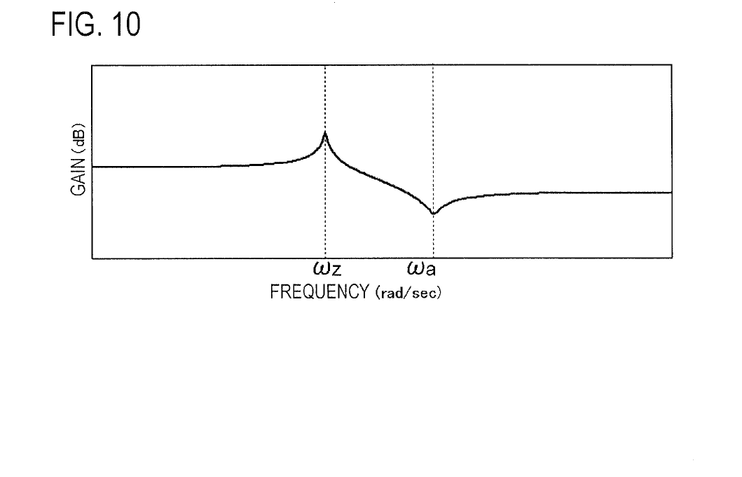

The transfer function Pr (s) of the natural vibration reduction processing 60 includes frequency characteristics that reduce the vibrational component of the resonant frequency ωa of the power transmission path 2, as shown in the Bode plot of FIG. 10.

In addition, each controlling constant of the input torque estimator 55 is changed in accordance with the speed ratio Kr that changes in accordance with the shift speed of the speed change mechanism TM, as shown in Equation (2).

Alternatively, the natural vibration reduction processing 60 may be configured to set to filter processing that cuts off natural vibration in a frequency range around the resonant frequency ωa of the power transmission path 2. Low-pass filer processing or band-pass filter processing may be utilized as such filter processing. Also, in such a case, filter frequency range is changed in accordance with the speed ratio Kr.

Alternatively, the vibration characteristics of the power transmission path 2 may be modeled in a higher-order transfer function, and the natural vibration reduction processing 60 may be set based on the inverse transfer characteristics. Alternatively, the natural vibration reduction processing 60 may be set based on the inverse transfer characteristics of the transfer characteristics of the power transmission path 2 that was acquired experimentally.

<Estimation of External Input Torque>

In addition, as shown in Equation (1), the transmission path input torque Tin includes, in addition to the external input torque Tw, the output torque Tm of the rotary electric machine MG and the first slip torque Tf. Thus, in order to estimate the external input torque Tw inputted from the wheels W to the power transmission path 2 based on the estimated transmission path input torque Tine, it is understood that subtracting at least the output torque Tm of the rotary electric machine MG is necessary. In addition, in a case in which the first engagement device CL1 is in the slip engagement state and the first slip torque Tf is generated, it is necessary to further subtract the first slip torque Tf in addition to the subtraction of the output torque Tm of the rotary electric machine MG.

Thus, the external input estimator 51 is configured to estimate the external input torque Tw by subtracting at least the output torque Tm of the rotary electric machine MG from the estimated transmission path input torque Tine.

In the present embodiment, during the execution of the direct rotational speed control, the first engagement device CL1 is in the slip engagement. Therefore, the external input estimator 51 is configured to estimate the external input torque Tw by subtracting the output torque Tm of the rotary electric machine MG from the estimated transmission path input torque Tine as well as adding the absolute value of the estimated first slip torque Tfe. Here, the external input estimator 51 estimates the torque (Tw/Kr) acquired by dividing the external input torque Tw by the speed ratio Kr. Thus, the estimated external input torque Twre is an estimated value of Tw/Kr. Hereinafter, the external input torque Tw/Kr, which is a converted value on the rotary electric machine MG side, is simply referred to as the external input torque Tw.

Here, in the present embodiment, the response lag in the torque output with respect to a request value is small in the rotary electric machine MG. Therefore, the rotary electric machine required torque Tmo is set to the output torque Tm of the rotary electric machine MG.

In addition, while the transmission torque capacity of the first engagement device CL1 is increasing, an estimated error in the estimated first slip torque Tfe could cause an estimated error in the estimated external output torque Twre because of a fluctuation from an actual external input torque Tw.

Thus, the external input estimator 51 may be configured to maintain the estimated external input torque Twre that was estimated before the increase of the transmission torque capacity at least while the transmission torque capacity of the first engagement device CL1 is increasing. Thereby, the occurrence of the estimated error in the estimated external input torque Twre can be suppressed.

3-4-2-4. Low Vibration Velocity Calculator

The low vibration velocity calculating unit 52 calculates the direct target rotational speed ωmo based on the estimated external input torque Twre and the vehicle required torque Tr that is torque required to drive the wheels W, as mentioned above. The direct target rotational speed ωmo is the rotational speed after the vibrational component of the the rotational speed ωm of the rotary electric machine MG is reduced.

In the present embodiment, as shown in FIG. 7, the low vibration velocity calculating unit 52 is configured to calculate a rotational acceleration (angular acceleration) by performing division processing of dividing the torque that is acquired by adding the estimated external input torque Twre to the vehicle required torque Tr by the inertia moment 3 of the entire power transmission path 2, and calculate the direct target rotational speed ωmo by performing integral arithmetic processing of the rotational acceleration.

3-4-2-5. Rotational Speed Control Unit

The rotational speed control unit 53 calculates the rotational control torque request Tp that causes the rotational speed ωm of the rotary electric machine MG to approach the direct target rotational speed ωmo.

In the present embodiment, as shown in FIG. 7, the rotational speed control unit 53 is configured to calculate the rotational control torque request Tp by performing feedback control based on the rotational speed deviation Δωm that is acquired by subtracting the rotational speed ωm of the rotary electric machine MG from the direct target rotational speed ωmo.

Various kinds of feedback control units such as a PID control unit and a PI control unit can be utilized as the rotational speed control unit 53.

The accumulator 54 is configured to set, as the rotary electric machine required torque Tmo, a value acquired by adding the basic rotary electric machine required torque Tb to the rotational control torque request Tp. The basic rotary electric machine required torque Tb is calculated by adding the vehicle required torque Tr to the absolute value of the estimated first slip torque Tfe.

Note that the absolute value of the estimated first slip torque Tfe that is added to the vehicle required torque Tr is a feedforward control term with respect to the change in the first slip torque Tf and the rotational control torque request Tp is a feedback control term with respect to the change in the first slip torque Tf. In addition, the value of the rotational control torque request Tp may be configured to be set as the rotary electric machine required torque Tmo without adding the basic rotary electric machine required torque Tb.

3-4-2-6. Behavior of Direct Rotational Speed Control

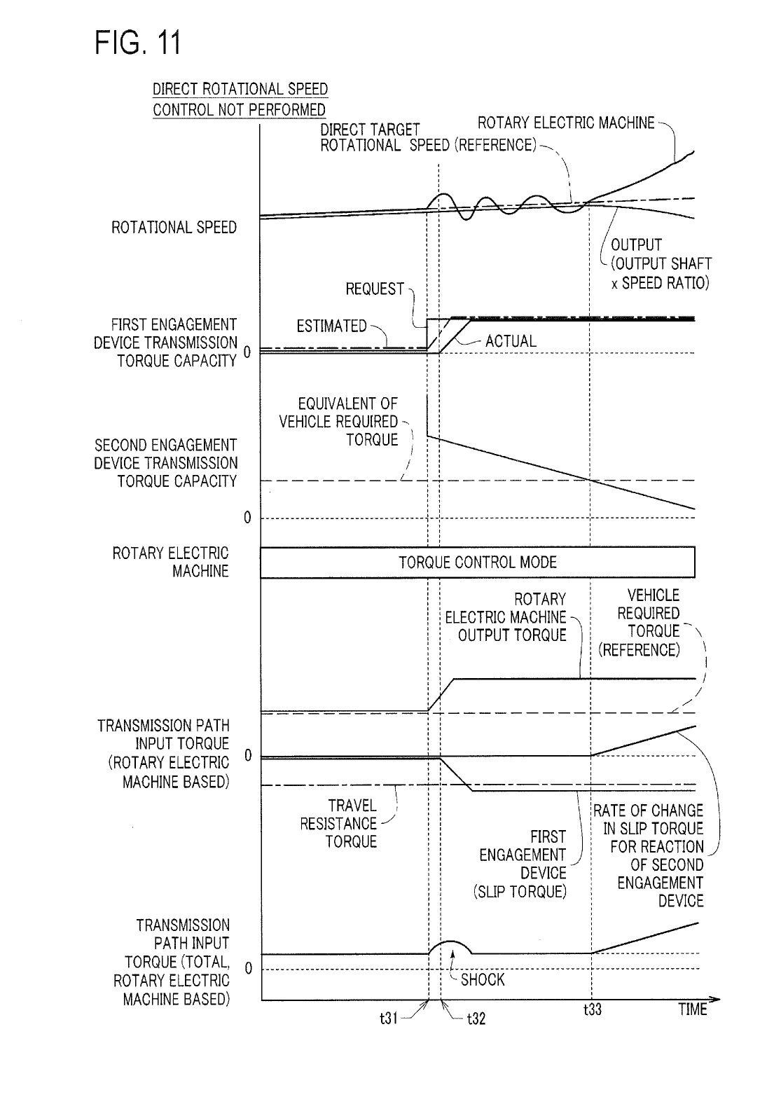

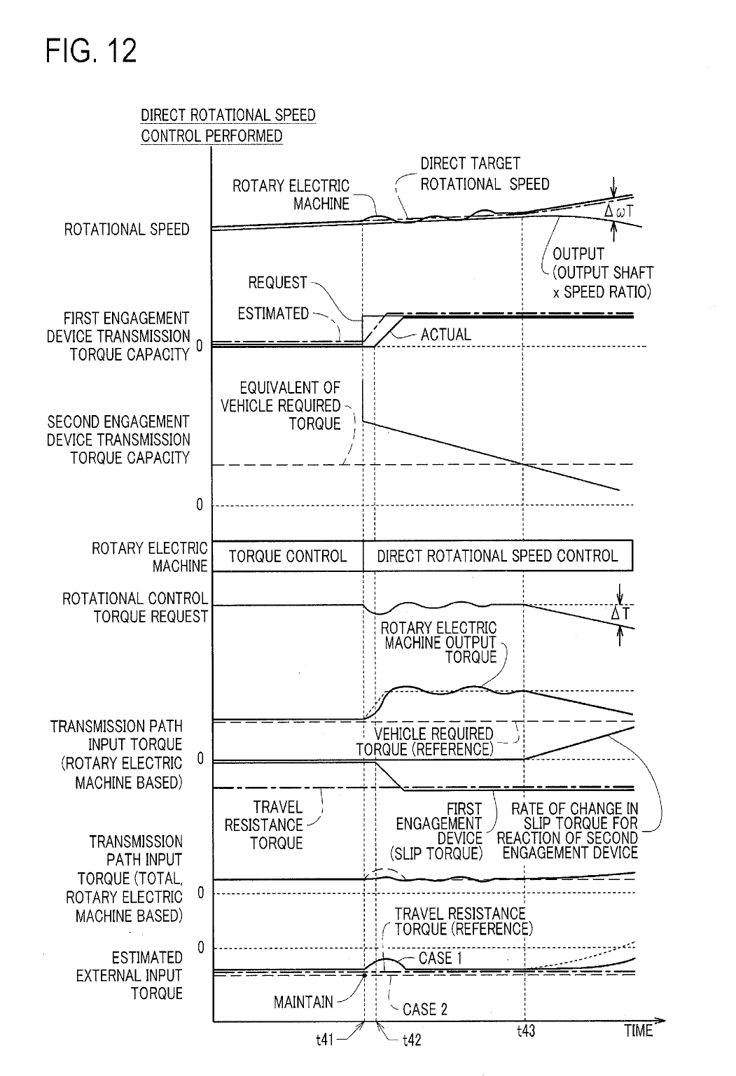

Subsequently, the behavior of the direct rotational speed control by the direct rotational speed control section 47 is explained with reference to the time chart shown in the examples of FIGS. 11 and 12. FIG. 11 shows a comparison example in a case in which the direct rotational speed control is not performed. FIG. 12 is an example in a case in which the direct rotational speed control is performed.

<Case without Direct Rotational Speed Control>

Initially, the comparison example of FIG. 11 is explained. When a request to start an engine is provided (time t31), the first target torque capacity of the first engagement device CL1 is increased from zero to the starting torque and the sweep-down that gradually decreases the second target torque capacity of the second engagement device CL2 from the full engagement capacity starts. After the first target torque capacity of the first engagement device CL1 is increased, the actual transmission torque capacity changes with response lag of the hydraulic pressure supply system. In the present example, an error in a direction of phase lead with respect of the actual transmission torque capacity is caused in the estimated value of the transmission torque capacity, and an estimated error in a direction of phase lead is also caused in the estimated first slip torque Tfe that is calculated by multiplying the estimated value by a negative sign.

Due to this estimated error, an error in a direction of phase lead is also caused in the change in the basic rotary electric machine required torque Tb that is calculated by adding the absolute value of the estimated first slip torque Tfe to the vehicle required torque Tr so as to cancel the change in the first slip torque Tf. Thus, the total torque of the output torque Tm of the rotary electric machine MG and the first slip torque Tf fluctuates from the vehicle required torque Tr at the timing when the transmission torque capacity of the first engagement device CL1 changes, thereby torque shock is caused. Due to this torque shock, the torsion of the output shaft is caused, the rotational speed ωm of the rotary electric machine MG fluctuates, and the vibration of the resonance frequency is excited in a shaft torsional vibration system. In the example shown in FIG. 11, the direct rotational speed control is not performed. Therefore, the damping of vibration is small and the vibration continues even after the vibrational excitation. The direct target rotational speed ωmo that is calculated in a case in which the direct rotational speed control is performed is shown for reference. It is understood that the rotational speed ωm of the rotary electric machine MG vibrates centering at the direct target rotational speed ωmo and damping of the vibration is possible by performing the direct rotational speed control.

The second target torque capacity is gradually decreased through the sweep-down. When the torque transmitted from the rotary electric machine MG to the second engagement device CL2 falls below the torque that corresponds to the vehicle required torque, slip starts to occur between the engagement members of the second engagement device CL2 (time t33).

When the second engagement device CL2 is brought into the slip engagement state, the torque transmitted from the rotary electric machine MG to the wheels W through the second engagement device CL2 becomes the slip torque that corresponds to the transmission torque capacity. After the second engagement device CL2 is brought into the slip engagement state, the second target torque capacity is gradually decreased until it is determined that the second engagement device CL2 is brought into the slip engagement state. Therefore, the slip torque transmitted from the second engagement device CL2 to the wheels W is gradually decreased below the vehicle required torque. In addition, as a reaction, the slip torque transmitted from the second engagement device CL2 to the rotary electric machine MG gradually increases. In FIG. 11, an increase amount in the reaction slip torque from the time point when the second engagement device CL2 is brought into the slip engagement state is indicated as a reaction slip torque change amount of the second engagement device CL2. Therefore, the transmission path input torque Tin (total value) acting on the rotary electric machine MG increases in accordance with the increase in the reaction slip torque change amount of the second engagement device CL2 after the second engagement device CL2 is brought into the slip engagement state. Thereby, the rate of change of the rotational speed ωm of the rotary electric machine MG increases. On the other hand, the transmission path input torque Tin (total value) acting on the wheels W decreases in accordance with the decrease in the slip torque of the second engagement device CL2 after the second engagement device CL2 is brought into the slip engagement state, although not shown in FIG. 11. Thus, the rate of change of the output rotational speed decreases. Here, the inertia moment Jm of the rotary electric machine MG is smaller than the inertia moment Jl of the load (vehicle). Therefore, the increase amount (absolute value) of the rate of change of the rotational speed ωm of the rotary electric machine MG is greater than the decrease amount (absolute value) of the rate of change of the output rotational speed. Note that, when the second engagement device CL2 is brought into the slip engagement state, the shaft torsion between the rotary electric machine MG and the load (vehicle) is not caused. Thus, the rotary electric machine MG and the load (vehicle) are separated in each independent inertia system, and the rotational speeds change in inverse proportion to the respective inertia moments.

<Case with Direct Rotational Speed Control>

Subsequently, FIG. 12 shows an example according to the present embodiment in a case in which the direct rotational speed control starts when a request to start an engine is provided under the same operation condition as FIG. 11 (time t41). Through the direct rotational speed control, the rotational control torque request Tp is calculated in accordance with a deviation Δω between the direct target rotational speed ωmo and the rotational speed ωm of the rotary electric machine MG. Thereby, the output torque Tm of the rotary electric machine MG changes by an amount of change of the rotational control torque request Tp with respect to the basic rotary electric machine required torque Tb. In addition, the total value of the transmission path input torque Tin changes by an amount of change of the rotational control torque request Tp compared to the case without control shown in FIG. 11, and the torque shock is reduced.

The reduction in the torque shock is explained. The estimated error is caused in the estimated external input torque Twre with respect to the actual external input torque (travel resistance torque) due to the estimated error in the estimated first slip torque Tfe. However, the direct target rotational speed ωmo is calculated by performing division processing of the estimated external input torque Twre by the inertia moment J of the entire power transmission path 2. Therefore, the torque shock caused by the estimated error in the estimated first slip torque Tfe is less likely to occur in the direct target rotational speed ωmo. On the other hand, the inertia moment Jm of the rotary electric machine MG is small in relation to the inertia moment J of the entire power transmission path 2, and the rotary electric machine MG is coupled to the load L on the vehicle side via a shaft having elasticity. Therefore, the influence of the torque shock caused by the estimated error in the estimated external input torque Twre is likely to occur in the rotational speed ωm of the rotary electric machine MG. Thus, the torque shock can be suppressed by calculating the rotational control torque request Tp that causes the rotational speed ωm of the rotary electric machine MG to approach the direct target rotational speed ωmo.

In the example shown in FIG. 12, there is no change in either the vehicle required torque Tr or the external input torque (travel resistance torque). However, in a case in which they change, the acceleration of the direct target rotational speed ωmo can be changed in accordance with such changes in a feedforward manner. Thereby, it is possible to achieve the behavior that the direct target rotational speed ωmo changes without delay in accordance with the changes in the vehicle required torque Tr and the external input torque. Thus, it is possible not to cause a time lag in the behavior of the rotational speed ωm of the rotary electric machine MG even in a case in which the direct rotational speed control is performed.

Besides the aforementioned case 1, a case 2 is an example in which the estimated external input torque Twre that was estimated before the increase in the transmission torque capacity is maintained while the transmission torque capacity of the first engagement device CL1 keeps increasing. In the example of the case 2, the estimated external input torque Twre is configured to be calculated by the external input estimator 51 even before starting the direct rotational speed control, and the estimated external input torque Twre before starting the direct rotational speed control is configured to be maintained. Thereby, even in a case in which an estimated error in the estimated first slip torque Tfe is caused, the occurrence of the estimated error in the estimated external input torque Twre can be suppressed.

When slip starts to occur between the engagement members of the second engagement device CL2 through the sweep-down for the second target torque capacity (subsequent to time t43), the rate of change of the rotational speed ωm of the rotary electric machine MG starts to increase due to the increase in the reaction slip torque change amount of the second engagement device CL2. The direct rotational speed control section 47 calculates the rotational control torque request Tp so as to suppress the increase in the rate of change. Specifically, the direct rotational speed control section 47 estimates the estimated external input torque Tine based on the rotational speed after the vibrational component of the rotational speed ωm of the rotary electric machine MG is reduced through the natural vibration reduction processing 60. Therefore, the influence of the increase in the reaction slip torque change amount is reduced and reflected into the external input torque Tine. Thus, the increase in the direct target rotational speed ωmo is lowered compared to the increase in the rotational speed ωm of the rotary electric machine MG in a case in which the direct rotational speed control is not performed as shown in FIG. 11. Therefore, the rotational control torque request Tp is decreased so as to suppress the increase in the rotational speed ωm of the rotary electric machine MG due to the increase in the reaction slip torque change amount. That is, in order to bring the rotational speed ωm of the rotary electric machine MG that tries to increase to be closer to the direct target rotational speed ωmo, the rotational control torque request Tp is decreased as the reaction slip torque change amount increases. On the other hand, even in a case in which the output torque Tm of the rotary electric machine MG is decreased due to the decrease in the rotational control torque request Tp, because the second engagement device CL2 is in the slip engagement state, the decrease in the output torque Tm of the rotary electric machine MG has no influence on the wheels W and the output rotational speed (the rotational speed of the wheels W) lowers in accordance with the decrease in the slip torque of the second engagement device CL2 in the same manner as in FIG. 11.

In such a manner, the rotational speed difference between the rotational speed of the rotary electric machine MG and the output rotational speed is generated by the rotational speed of the wheels W (rotational speed of the output shaft O) falling below the rotational speed of the wheels W (rotational speed of output shaft O) in a case in which the second engagement device CL2 is in the direct engagement state when the rotational speed of the rotary electric machine MG is controlled so as to achieve the direct target rotational speed.

Here, the rotational speed difference between the rotational speed of the rotary electric machine MG and the output rotational speed corresponds to the rotational speed difference between the engagement members of the second engagement device CL2. In addition, here, the rotational speed of the rotary electric machine MG is controlled so as to achieve the direct target rotational speed, and it is assumed that the rotational speed of the rotary electric machine MG coincides with the direct target rotational speed.

Thus, even in a case in which the direct rotational speed control is performed, the rotational speed difference Δω1 between the rotational speed ωm of the rotary electric machine MG and the output rotational speed increases after the second engagement device CL2 is brought into the slip engagement state (subsequent to time t43). The start control section 46 determines that the second engagement device CL2 is brought into the slip engagement state when the rotational speed difference Δω1 becomes equal to or greater than a predetermined rotational speed difference.

In addition, after the second engagement device CL2 is brought into the slip engagement state (subsequent to time t43), the rotational control torque request Tp decreases from zero. Therefore, the start control section 46 can determine that the second engagement device CL2 has been brought into the slip engagement state also when the change amount Δ1 (absolute value) of the rotational control torque request Tp in the decrease direction from zero becomes equal to or greater than a predetermined value.

### Other Embodiments

Lastly, other embodiments of the present invention are explained. A configuration disclosed in each of the embodiments described below is not limited to be applied separately. The configuration may be applied in combination with a configuration disclosed in any other embodiment unless any contradiction occurs.

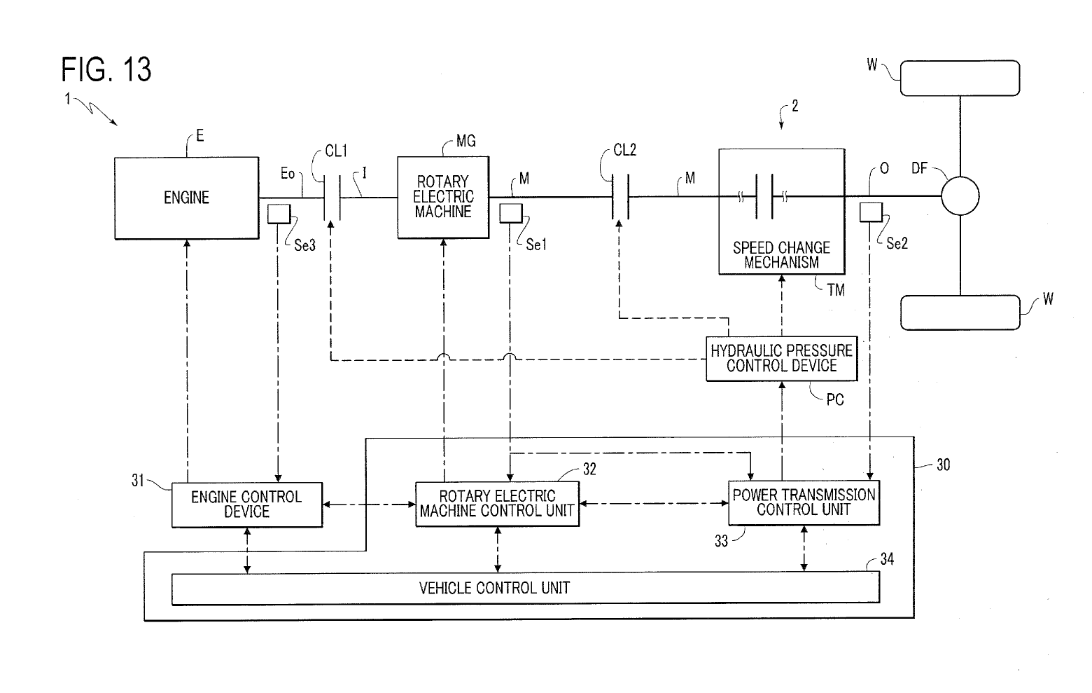

(1) In the present embodiment described above, a case is exemplified, in which one of a plurality of engagement devices of the speed change mechanism TM is set as the second engagement device CL2 whose engagement state is controlled during the start control of the engine E. However, embodiments of the present invention are not limited thereto. As shown in FIG. 13, the vehicle drive device 1 may include a further engagement device between the rotary electric machine MG and the speed change mechanism TM on the power transmission path 2, and may be configured such that the engagement device is set as the second engagement device CL2 whose engagement state is controlled during the start control of the engine E. Alternatively, the speed change mechanism TM may not be provided in the vehicle drive device 1 shown in FIG. 13.

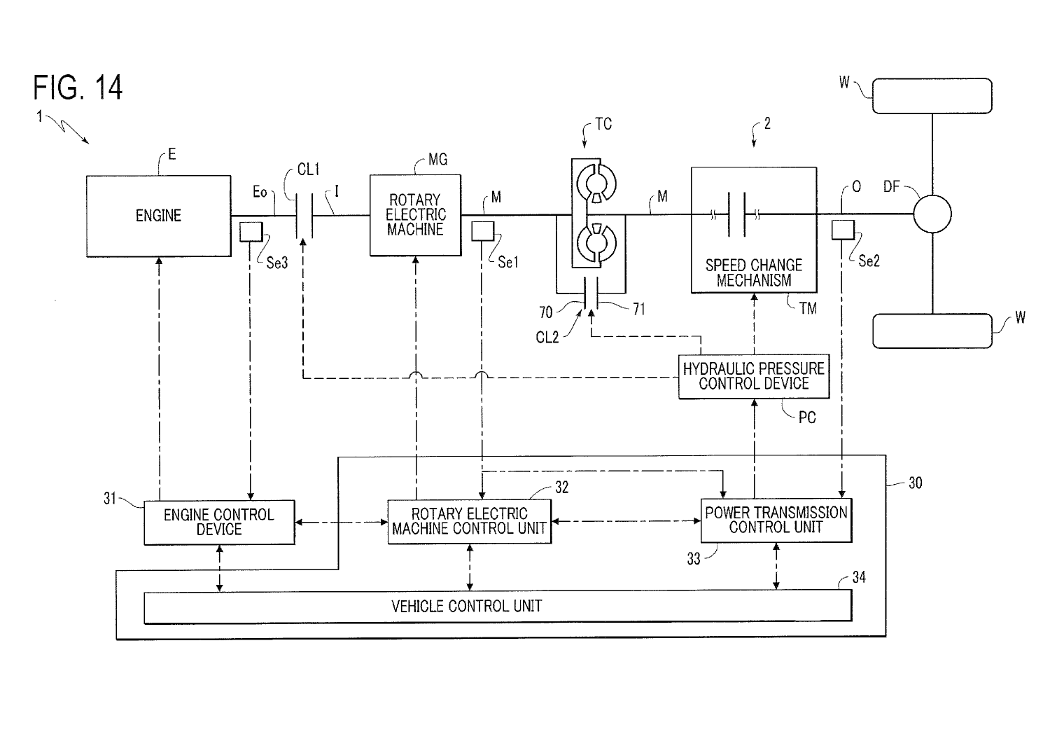

Alternatively, as shown in FIG. 14, the vehicle drive device 1 further include a torque converter TC between the rotary electric machine MG and the speed change mechanism TM on the power transmission path, and may be configured such that a lockup clutch that realizes the direct engagement state between the input output members of the torque converter TC is set as the second engagement device CL2 whose engagement state is controlled during the start control of the engine E.

(2) In the aforementioned embodiment, a case was explained as an example, in which the first engagement device CL1 and the second engagement device CL2 are engagement devices that are controlled with hydraulic pressure. However, embodiments of the present invention are not limited thereto. One or both of the first engagement device CL1 and the second engagement device CL2 may be engagement devices that are controlled with driving force other than hydraulic pressure, for example, electromagnetic driving force, driving force by servomotor, etc.

(3) In the aforementioned embodiment, a case was explained as an example, in which the speed change mechanism TM is an automatic stepped speed change mechanism. However, embodiments of the present invention are not limited thereto. The speed change mechanism TM may be configured to be a speed change mechanism other than the automatic speed change mechanism, such as an automatic continuously variable transmission that is capable of continuously changing the speed ratio. Also, in such a case, an engagement device provided in the speed change mechanism TM may be set as the second engagement device CL2 whose engagement state is controlled during the start control of the engine E. Alternatively, an engagement device installed separately from the speed change mechanism TM may be set as the second engagement device CL2.

(4) In the aforementioned embodiment, a case was explained as an example, in which the control device 30 includes a plurality of control units 32 to 34 and these plurality of control units 32 to 34 include a plurality of control sections 41 to 47. However, embodiments of the present invention are not limited thereto. The control device 30 may include the aforementioned plurality of control units 32 to 34 as control devices which are integrated or separated in any combination. The allocation of the plurality of function sections 41 to 47 to the plurality of control units 32 to 34 can be made as desired. For example, in a case in which the first engagement device CL1 is one of the engagement device of the speed change mechanism TM, the speed change mechanism control section 43 and the first engagement device control section 44 may be integrated.

(5) In the aforementioned embodiment, a case was explained as an example, in which, when a request to start the engine E is provided, the start control section 46 starts, at the same time, the direct rotational speed control for the rotary electric machine MG, the first transition control that causes the first engagement device CL1 to transition from the disengaged state to the slip engagement state, and the second transition control that causes the second engagement device CL2 to transition from the direct engagement state to the slip engagement state. However, embodiments of the present invention are not limited thereto. After the request to start the engine E is provided, the start control section 46 may start the first transition control for the first engagement device CL1 and the second transition control for the second engagement device CL2, and before the first engagement device CL1 is brought from the disengaged state into the slip engagement state, starts the rotational speed control that controls the rotary electric machine MG such that the rotational speed of the rotary electric machine MG achieves the target rotational speed. Consequently, after the request to start the engine E is provided, the starting time point of the direct rotational speed control for the rotary electric machine MG, the starting time point of the first transition control for the first engagement device CL1, and the starting time point of the second transition control for the second engagement device CL2 may be different. For example, when a request to start the engine E is provided, the start control section 46 may start the direct rotational speed control for the rotary electric machine MG and the first transition control for the first engagement device CL1, and thereafter, start the second transition control for the second engagement device CL2.

(6) In the aforementioned embodiment, a case was explained as an example, in which, in order to generate transmission torque capacity in the first engagement device CL1, when a request to start the engine E is provided, the start control section 46 increases the first target torque capacity of the first engagement device CL1 from zero to predetermined starting torque. However, embodiments of the present invention are not limited thereto. After the request to start the engine E is provided, in order to cause the first engagement device CL1 to transition from the disengaged state to the slip engagement state, the start control section 46 may provide a request to generate transmission torque capacity in the first engagement device CL1 and start the first transition control. For example, before a request to start the engine E is provided, the start control section 46 may be configured to previously execute control that supplies to the first engagement device CL1 a preliminary hydraulic pressure that is low enough not to generate transmission torque capacity such that the first engagement device CL1 can transition to the slip engagement state immediately after the request to start the engine E is provided, and after the request to start the engine E is provided, start the first transition control that increases the hydraulic pressure from the preliminary hydraulic pressure to a hydraulic pressure with which transmission torque capacity is generated. Note that the control that supplies a preliminary hydraulic pressure that is low enough not to generate transmission torque capacity is not included in the first transition control and the control to increase the hydraulic pressure from the preliminary hydraulic pressure to the hydraulic pressure with which transmission torque capacity is generated is included in the first transition control.

The present invention may be preferably applied to a control device that controls a vehicle drive device in which a rotary electric machine is provided on a power transmission path connecting an input member that is drivingly coupled to an internal combustion engine to wheels, a first engagement device is provided between the internal combustion engine and the rotary electric machine, and a second engagement device is provided between the rotary electric machine and the wheels.

### DESCRIPTION OF THE REFERENCE NUMERALS

1 VEHICLE DRIVE DEVICE
2 POWER TRANSMISSION PATH
30 CONTROL DEVICE
31 ENGINE CONTROL DEVICE
32 ROTARY ELECTRIC MACHINE CONTROL UNIT
33 POWER TRANSMISSION CONTROL UNIT
34: VEHICLE CONTROL UNIT
41: ENGINE CONTROL SECTION
42: ROTARY ELECTRIC MACHINE CONTROL SECTION
43: SPEED CHANGE MECHANISM CONTROL SECTION
44: FIRST ENGAGEMENT DEVICE CONTROL SECTION
45: SECOND ENGAGEMENT DEVICE CONTROL SECTION
46: START CONTROL SECTION
47: DIRECT ROTATIONAL SPEED CONTROL SECTION
51: EXTERNAL INPUT ESTIMATOR
52: LOW VIBRATION VELOCITY CALCULATING UNIT
53: ROTATIONAL SPEED CONTROL UNIT
ωm ROTATIONAL SPEED OF ROTARY ELECTRIC MACHINE
ωmo DIRECT TARGET ROTATIONAL SPEED
AX AXLE SHAFT
CL1 FIRST ENGAGEMENT DEVICE
CL2 SECOND ENGAGEMENT DEVICE
DF OUTPUT DIFFERENTIAL GEAR DEVICE
E ENGINE (INTERNAL COMBUSTION ENGINE)
Eo ENGINE OUTPUT SHAFT (INPUT MEMBER)
I INPUT SHAFT
J INERTIA MOMENT OF ENTIRE POWER TRANSMISSION PATH
Jl INERTIA MOMENT OF LOAD (VEHICLE)
Jm INERTIA MOMENT OF ROTARY ELECTRIC MACHINE
Kr SPEED RATIO
L LOAD (VEHICLE)
M INTERMEDIATE SHAFT
O OUTPUT SHAFT
MG ROTARY ELECTRIC MACHINE
PC HYDRAULIC PRESSURE CONTROL DEVICE
Se1 INPUT ROTATIONAL SPEED SENSOR
Se2 OUTPUT ROTATIONAL SPEED SENSOR
Se3 ENGINE ROTATIONAL SPEED SENSOR
TM SPEED CHANGE MECHANISM
Tb BASIC ROTARY ELECTRIC MACHINE REQUIRED TORQUE
Tf FIRST SLIP TORQUE
Tfe ESTIMATED FIRST SLIP TORQUE
Tin TRANSMISSION PATH INPUT TORQUE
Tine ESTIMATED TRANSMISSION PATH INPUT TORQUE
Tm OUTPUT TORQUE OF ROTARY ELECTRIC MACHINE
Tmo ROTARY ELECTRIC MACHINE REQUIRED TORQUE
Tp ROTATIONAL CONTROL TORQUE REQUEST
Tr VEHICLE REQUIRED TORQUE
Tw EXTERNAL INPUT TORQUE
Twre ESTIMATED EXTERNAL INPUT TORQUE
W WHEEL

1-6. (canceled)

7. A control device that controls a vehicle drive device in which a rotary electric machine is arranged on a power transmission path that connects an internal combustion engine to wheels, a first engagement device is arranged between the internal combustion engine and the rotary electric machine, and a second engagement device is arranged between the rotary electric machine and the wheels, wherein,
in response to a request to start the internal combustion engine that is received while the first engagement device is in a disengaged state and the second engagement device is in a direct engagement state, the control device performs start control for the internal combustion engine that increases a rotational speed of the internal combustion engine using a rotational driving force of the rotary electric machine, the start control comprising:
after the request to start the internal combustion engine is received, starting first transition control that causes the first engagement device to transition from the disengaged state to a slip engagement state and second transition control that causes the second engagement device to transition from the direct engagement state to the slip engagement state;
before the first engagement device transitions from the disengaged state to the slip engagement state, starting rotational speed control that controls the rotary electric machine such that a rotational speed of the rotary electric machine achieves a target rotational speed;
in a state in which the second engagement device is brought into a specified slip engagement state, or in which an amount of change, in a decreasing direction, of output torque caused by the rotational speed control becomes equal to or greater than a specified value, determining that the second engagement device has transitioned from the direct engagement state to the slip engagement state; and
after it is determined that the second engagement device has transitioned from the direct engagement state to the slip engagement state, causing the first engagement device to transition from the slip engagement state to the direct engagement state.

8. The control device according to claim 7, wherein,
in the rotational speed control,
the control device:
before it is determined that the second engagement device has transitioned from the direct engagement state to the slip engagement state,
estimates, based on a change in the rotational speed of the rotary electric machine, transmission path input torque that is inputted to the power transmission path;
estimates external input torque that is inputted from the wheels to the power transmission path, by subtracting at least output torque of the rotary electric machine from the transmission path input torque; and
sets, as the target rotational speed, a rotational speed that is calculated based on the external input torque and vehicle required torque that is required to drive the wheels; and
after it is determined that the second engagement device has transitioned from the direct engagement state to the slip engagement state, sets, as the target rotational speed, a rotational speed that is higher, by a specified value, than the rotational speed of the rotary electric machine in a case in which the second engagement device is in the direct engagement state.

9. The control device according to claim 7, wherein:
the disengaged state of the first engagement device is a state in which no transmission torque capacity is generated in the first engagement device,
the slip engagement state of the first engagement device is a state in which transmission torque capacity is generated in the first engagement device and there is a difference between the rotational speed of the internal combustion engine and the rotational speed of the rotary electric machine,
the direct engagement state of the first engagement device is a state in which transmission torque capacity is generated in the first engagement device and there is no difference between the rotational speed of the internal combustion engine and the rotational speed of the rotary electric machine,
the slip engagement state of the second engagement device is a state in which transmission torque capacity is generated in the second engagement device and there is a difference between rotational speeds of two engagement members of the second engagement device, and
the direct engagement state of the second engagement device is a state in which transmission torque capacity is generated in the second engagement device and there is no difference between the rotational speeds of the two engagement members of the second engagement device.

10. The control device according to claim 9, wherein:
starting the first transition control comprises providing a request to cause the first engagement device to generate transmission torque capacity, and
starting the second transition control comprises providing a request to gradually decrease the transmission torque capacity generated in the second engagement device until a difference between the rotational speeds of the two engagement members of the second engagement device is generated.

11. The control device according to claim 7, wherein,
during the rotational speed control,
the control device causes the first engagement device to transition from the disengaged state to the slip engagement state, and thereafter, causes the second engagement device to transition from the direct engagement state to the slip engagement state.

12. The control device according to claim 7, wherein:
the specified slip engagement state is a state in which a value that corresponds to a rotational speed difference between the engagement members of the second engagement device, and that is calculated based on the rotational speed of the rotary electric machine and the rotational speed of the wheels, becomes equal to or greater than a specified value, and
the value that corresponds to the rotational speed difference between the engagement members of the second engagement device is generated by the rotational speed of the wheels falling below the rotational speed of the wheels that occurs in a case in which the second engagement device is in the direct engagement state when the rotational speed of the rotary electric machine is controlled so as to achieve the target rotational speed.

13. A method of controlling a vehicle drive device in which a rotary electric machine is arranged on a power transmission path that connects an internal combustion engine to wheels, a first engagement device is arranged between the internal combustion engine and the rotary electric machine, and a second engagement device is arranged between the rotary electric machine and the wheels, the method comprising:
in response to a request to start the internal combustion engine that is received while the first engagement device is in a disengaged state and the second engagement device is in a direct engagement state, performing start control for the internal combustion engine that increases a rotational speed of the internal combustion engine using a rotational driving force of the rotary electric machine, the start control comprising:
after the request to start the internal combustion engine is received, starting first transition control that causes the first engagement device to transition from the disengaged state to a slip engagement state and second transition control that causes the second engagement device to transition from the direct engagement state to the slip engagement state;
before the first engagement device transitions from the disengaged state to the slip engagement state, starting rotational speed control that controls the rotary electric machine such that a rotational speed of the rotary electric machine achieves a target rotational speed;
in a state in which the second engagement device is brought into a specified slip engagement state, or in which an amount of change, in a decreasing direction, of output torque caused by the rotational speed control becomes equal to or greater than a specified value, determining that the second engagement device has transitioned from the direct engagement state to the slip engagement state; and
after it is determined that the second engagement device has transitioned from the direct engagement state to the slip engagement state, causing the first engagement device to transition from the slip engagement state to the direct engagement state.
